(19) United States
(12) Patent Application Publication
(10) Pub. No.: US 2005/0010465 A1
(43) Pub. Date: Jan. 13, 2005

(54) System and method for matching user indentified environmental projects with resource providers

(75) Inventors: Ellen E. Drew, Golden, CO (US); Nicole S. Maloney, Denver, CO (US)

Correspondence Address: PATTON BOGGS, 1660 LINCOLN ST, SUITE 2050, DENVER, CO, 80264, US

(73) Assignee: StEPP Foundation, Golden, CO (US)

(21) Appl. No.: 10/616,738

(22) Filed: Jul. 9, 2003

(51) Int. Cl. G06F 17/60

(52) U.S. Cl. 705/9

(57) ABSTRACT

The Environmental Project Pipeline System includes a central station that provides concise environmental project surveys including criteria data categories to a plurality of users wishing to submit environmental project ideas, via a network, which is then displayed on the user's computer display and which further accepts input from the user's computer input device to select desired criteria data categories and complete the environmental project survey. These completed environmental project surveys are then transmitted back to the central station and stored on the central station's database. The Environmental Project Pipeline System's central station further stores data representative of resource provider's requirements for providing funding, equipment or in-kind support related to a desired environmental project on the central station database. The Environmental Project Pipeline System then matches appropriate environmental projects surveys criteria data categories with data representative of resource providers and then notifies the resource provider regarding the matched environmental project survey, users, or environmental projects. The Environmental Project Pipeline System generates reports based on selected criteria data categories and passes these reports on to the resource provider. In addition, the Environmental Project Pipeline System notifies user's regarding the submittal and status of their environmental project surveys.

### FIELD OF THE INVENTION

The present invention relates to a data identification and matching system and, in particular, to a system for matching publicly entered environmental projects with resource providers.

### Problem

It is a problem in the environmental field to efficiently and accurately match existing resource providers for clean energy, energy efficient, and pollution prevention projects with environmental projects identified by individuals or organizations within a community due to the lack of awareness of the existence of one group by the other and vice versa. Presently, if resource providers wish to fund environmental projects, they post or publish a request for proposal (RFP) requesting individuals and organizations to submit a response comprising voluminous amounts of information related to the type of environmental project the funding resource is interested in funding. Many individuals and organizations within a given community are working on leading edge projects incorporating clean energy, energy efficiency and pollution prevention techniques. These projects represent the natural next step for these organizations, in real time, and are often unfundable through the current system of foundation, corporate and government funding because the resource providers missions and grant language is often several to many years behind the leading edge activities of these organizations. The organizations seeking funding have little to no opportunities for funding these types of projects and the resource providers have little to no access to these projects. The processes for identifying opportunities to fund these types of environmental projects often do not exist. On the other side, resource providers are not aware of those environmental projects that may already exist in a specific community and that currently need to be implemented. Unless a response is filed to their RFP indicating language that is currently used by the funder or resource, the proposer has very little chance of a funder or resource acknowledging the need for their project. There is not currently a mechanism to identify real-time environmental project ideas by individuals or organizations within specific communities.

Furthermore, the information that is oftentimes requested in these RFP's is mission specific to the funder or resource, superfluous to the needs of the community so individuals and organizations spend extra time completing sections of a RFP that may represent tangents for their organizations. If the individuals and organizations responded to the RFP regarding the actual project they wanted to fund their RFP might not be looked at by the funding or resource, because of habit or custom. For the resource providers, sorting through these voluminous, non-standard, and sporadically completed responses becomes a huge sinkhole of valuable time. Thus, there is presently no system that is able to address the above-stated problems.

### Solution

The above-described problems are solved and a technical advance achieved in the art by the present Environmental Project Pipeline System, which provides users with access to a predetermined environmental project survey. The use of a predetermined environmental project survey enables users to quickly and efficiently enter criteria data category regarding their environmental projects and transmit the completed environmental project surveys to a central station, which stores the environmental project surveys to a relational database. The Environmental Project Pipeline System further provides users with the ability to input information related to resource providers that desire to provide funding, equipment, or in-kind contributions to environmental projects that meet the resource's criteria specific requirements. This resource information is stored at the central station database and is compared to efficiently match available resource providers with submitted environmental project surveys.

The Environmental Project Pipeline System eases the burden on users submitting environmental project ideas by providing an environmental project survey that efficiently requests from users relevant and pertinent environmental project information regarding their environmental project. Further, the Environmental Project Pipeline System enables users to easily submit, via the Internet or other communication means, completed environmental project surveys to a central station where they're stored to a relational database. Users submit one or more environmental projects to a central station without wasting time filling out and completing voluminous RFP's to be considered by resource providers. This reduces the burden on the user to discover these resource providers, by allowing the user to just focus on efficiently completing an environmental project survey related to their environmental project.

Furthermore, by efficiently searching stored environmental project surveys for matches with resource providers, the Environmental Project Pipeline System is able to quickly generate a list of those environmental project surveys that meet the resource's criteria specific requirements. The Environmental Project Pipeline System then notifies resource providers regarding those projects that meet their specific criteria. This enables the funding sources to simply submit their criteria specific funding requirements to a central station, which contains a plurality of stored environmental project surveys, to accomplish their goal of locating appropriate environmental projects that meet their submitted criteria.

The Environmental Project Pipeline System provides a user with an environmental project survey, which is presented in a manner to facilitate the user in efficiently and quickly entering their environmental projects into the Environmental Project Pipeline System. Specifically, the displayed environmental project survey presents quick entry text boxes, drop-down menus, and check boxes that include most facets, aspects and details of environmental projects thereby allowing a user to efficiently enter and submit their environmental project to the Environmental Project Pipeline System.

The Environmental Project Pipeline System communicates with users regarding the status of their submitted environmental project surveys and requests further information if it is needed. This frees the user from the burden of heading off on tangential projects that may or may not meet the needs of their constituency. Furthermore, the Environmental Project Pipeline System communicates with resource providers to provide them with up-to-date environmental project information that matches their specific funding criteria without having to receive, review and sort through voluminous submissions that may not meet their funding criteria.

Thus, the present Environmental Project Pipeline System creates an efficient pipeline for environmental project submissions from a multitude of individuals and organizations located throughout the world to be efficiently matched with appropriate funding sources.

### BRIEF DESCRIPTION OF THE DRAWINGS

FIG. 1 illustrates in block diagram form one embodiment of an Environmental Project Pipeline System according to the present invention;

FIGS. 2A-2C are screen shots depicting one embodiment of an Environmental Project Pipeline System according to the present invention;

FIGS. 2D-2I are screen shots depicting one embodiment of a category information section of an environmental project survey constructed according to the present invention;

FIG. 2J is a screen shot depicting one embodiment of a funding information section of an environmental project survey constructed according to the present invention;

FIG. 2K is a screen shot depicting one embodiment of a timeline information section of an environmental project survey constructed according to the present invention;

FIGS. 2L-2M are screen shots depicting one embodiment of a partner information section of an environment project survey constructed according to the present invention;

FIGS. 2N-2O are screen shots depicting one embodiment of a registration section of the system for matching user identified environmental projects with resource providers according to the present invention;

FIGS. 3A-3F are screen shots depicting one embodiment of a submittal summary form of the Environmental Project Pipeline System according to the present invention;

FIGS. 4A-4G are screen shots depicting one embodiment of a search criteria form for projects of the Environmental Project Pipeline System according to the present invention;

FIG. 5 is a screen shot depicting one embodiment of search results for projects of the Environmental Project Pipeline System according to the present invention;

FIG. 6 is a screen shot depicting one embodiment of a report selector of the Environmental Project Pipeline System according to the present invention;

FIGS. 7A-7C are screen shots depicting one embodiment of an email project information form of the Environmental Project Pipeline System according to the present invention;

FIG. 8 is a screen shot depicting one embodiment of a track project form of the Environmental Project Pipeline System according to the present invention;

FIG. 9 is a screen shot depicting one embodiment of an edit status information form of the Environmental Project Pipeline System according to the present invention;

FIG. 10 is a screen shot depicting one embodiment of a search criteria for request for proposals of the Environmental Project Pipeline System according to the present invention;

FIG. 11 is a screen shot depicting one embodiment of a search result for request for proposals of the Environmental Project Pipeline System according to the present invention;

FIG. 12 is a screen shot depicting one embodiment of an add request for proposals form of the Environmental Project Pipeline System according to the present invention;

FIG. 13 is a screen shot depicting one embodiment of an edit request for proposals form of the Environmental Project Pipeline System according to the present invention;

FIG. 14 is a screen shot depicting one embodiment of an edit resource provider form of the Environmental Project Pipeline System according to the present invention;

FIG. 15 is a screen shot depicting one embodiment of an apply new resource provider form of the Environmental Project Pipeline System according to the present invention;

FIG. 16 is a screen shot depicting one embodiment of a search criteria for form for applicants of the Environmental Project Pipeline System according to the present invention;

FIG. 17 is a screen shot depicting one embodiment of search results for applicants of the Environmental Project Pipeline System according to the present invention;

FIG. 18 is a screen shot depicting one embodiment of a project report selector form of the Environmental Project Pipeline System according to the present invention;

FIG. 19 is a screen shot depicting one embodiment of an email applicant's form of the Environmental Project Pipeline System according to the present invention;

FIG. 20 is a screen shot depicting one embodiment of an edit rights form of the Environmental Project Pipeline System according to the present invention;

FIGS. 21A-21B are screen shots depicting one embodiment of a domain management form of the Environmental Project Pipeline System according to the present invention;

FIG. 22 is a screen shot depicting one embodiment of an add domain form of the Environmental Project Pipeline System according to the present invention;

FIG. 23 is a screen shot depicting one embodiment of an edit domain form of the Environmental Project Pipeline System according to the present invention;

FIG. 24 illustrates users identifying environmental projects of the present Environmental Project Pipeline System;

FIG. 25 illustrates in flow diagram form the process executed in the present Environmental Project Pipeline System to match resource provider with a user identified environmental project;

FIG. 26 illustrates in flow diagram form the process executed in the present Environmental Project Pipeline System to inform a resource having specific criteria about matching identified environmental projects; and

FIG. 27 illustrates in flow diagram form the process executed in the present Environmental Project Pipeline System to generate a report from a database containing user identified environmental projects.

### DETAILED DESCRIPTION OF THE DRAWINGS

In the present Environmental Project Pipeline System, the phrase “environmental projects” typically means projects generally categorized as clean energy projects, energy efficient projects, and pollution prevention projects. These environmental projects may also include renewable energy projects and other types of beneficial environmental projects. The term “users” with regard to the Environmental Project Pipeline System means both those people who identify these environmental projects and submit them to the Environmental Project Pipeline System and those people who generate reports, notify resource providers and other users, and perform administrative tasks available with the Environmental Project Pipeline System. The term “resource providers” generally means those entities that provide funds, equipment, or in-kind support for these environmental projects. The term “RFP” means those data inquiries that generally request more specific and detailed information regarding an environmental project than the environmental project survey, however, an environmental project survey could include all of the information requested by the resource provider. The amount of information requested by a resource provider is specific to the criteria of that resource provider and will vary in degree from resource provider to resource provider. Therefore, these environmental project surveys may include less than, equal to, or more than the information of typical RFP's. These RFP's may be requested by the resource provider to the users who have submitted and been matched with the resource provider by the Environmental Project Pipeline System.

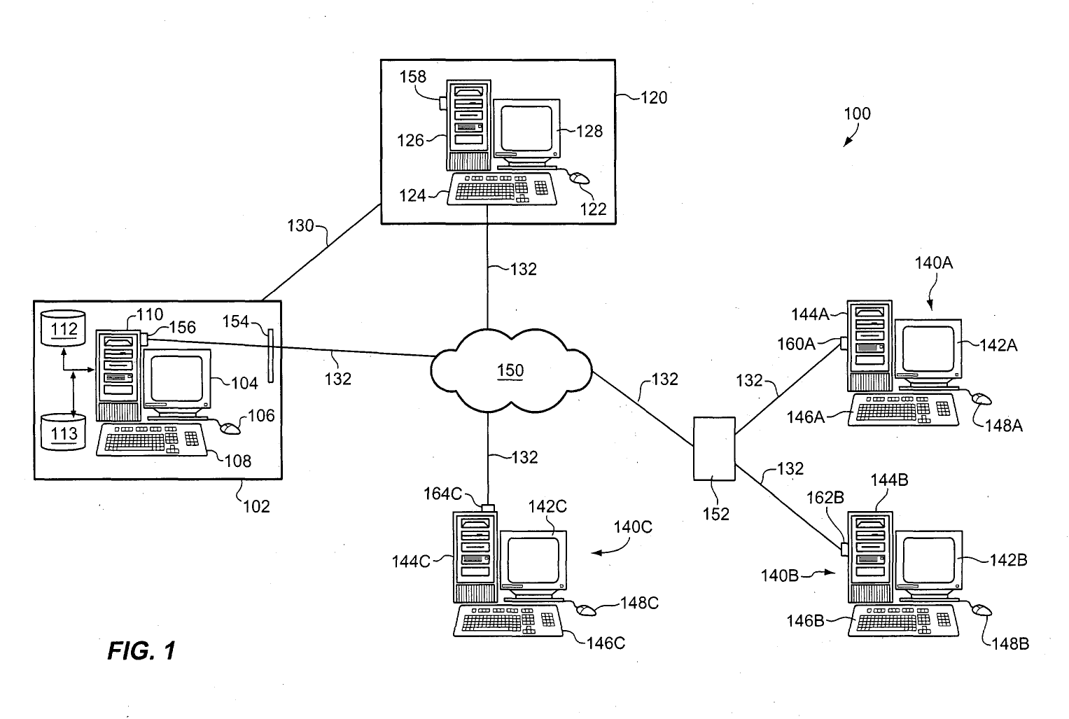

FIG. 1 illustrates a typical system environment in which the present Environmental Project Pipeline System is operational. This system architecture is simply illustrative of a typical configuration of computer processing resources and is intended to illustrate the issues that are encountered in the acquisition of environmental project surveys, storing of these surveys, sorting of these surveys, efficient matching of these surveys with resource providers, and the notifying a resource provider of at least one matching environmental project survey. This description is not intended to limit the applicability of the present Environmental Project Pipeline System to other system environments and is solely intended to provide a framework for the accompanying description of the present Environmental Project Pipeline System.

FIG. 1 is a block diagram of an Environmental Project Pipeline System 100 which comprises a central station 102, a resource provider 120, and users 140A, 140B, and 140C. Central station 102, resource provider 120, and users 140A, 140B, and 140C are coupled to one another and communicate through a network 150. Network 150 may comprise a plurality of communication lines 132. This is an illustration of a typical system architecture including several users 140A, 140B, and 140C. Users 140A and 140B are connected to the network 150 via an internal network or intranet 152. This is illustrated to show that several different users may be used with various connections, networks, and firewalls prior to the communication line 132 to the network 150. Additionally, an Environmental Project Pipeline System 100 may include more or less users 140A, 140B, and 140C than illustrated. Furthermore, one resource provider 120 is shown in FIG. 1, however, the Environmental Project Pipeline System 100 may include one or more resource providers 120.

Central station 102 preferably includes one or more input devices, such as a keyboard 108 or a mouse 106, one or more output devices, such as a printer or a display 104 and a communication device, such as a modem 156. Further, central station 102 preferably includes a server 110, a database 112, and an archive library 113. Server 110 may comprise a dedicated computer, with one or more processors, one or more input devices, one or more output devices, and one or more communication devices. Resource provider 120 preferably includes one or more input devices, such as a keyboard 124 or a mouse 122, one or more output devices, such as a printer or a display 128, a communication device, such as a modem 158, and a processor 126. User 140A preferably includes one or more input devices, such as a keyboard 146A or a mouse 148A, a communication device, such as a modem 160A, one or more output devices, such as a printer or a display 142A, and a processor 144A. User 140B preferably includes one or more input devices, such as a keyboard 146B or a mouse 148B, a communication device, such as modem 162B, one or more output devices, such as a printer or a display 142B, and a processor 144B. User 140C preferably includes one or more input devices, such as a keyboard 146C or a mouse 148C, a communication device, such as modem 164C, one or more output devices, such as a printer or a display 142C, and a processor 144C. Processor 144A, 144B, and 144C preferably further include either non-volatile memory or volatile memory or both.

Server 110 preferably comprises a mapping table. The mapping table may be a relational data structure that provides a correlation between an input and an output. Central station 102 may further comprise one or more firewalls 154. In one embodiment, firewall 154 may be located between network 150 and server 110. Firewall 154 protects central station 102 from both intentional and unintentional damage, which could pass through network 150. Firewall 154 may comprise hardware such as a computer with security measures, e.g., a dial-back feature, or may comprise defensive coding software. In general, firewall 154 receives data from network 150, determines whether the data could be harmful and, if not, transmits the data to server 110. In an alternative embodiment, one or more firewalls 154 may be placed between server 110 and database 112, between network 150 and server 110, between server 110 and archive 113, or in any other suitable location.

In general, the Environmental Project Pipeline System 100 of the present invention allows a central station 102 to survey users 140A, 140B, and 140C and to identify ones of such users 140A, 140B, and 140C that match a specific data criteria resource 120. This is accomplished by encouraging the users 140A, 140B, and 140C to complete a series of environmental, geographic, and sponsor questions contained on an environmental project survey. The users 140A, 140B, and 140C want to do this because at the end of the process the users 140A, 140B, and 140C may have their environmental project matched with a specific data criteria resource 120 which would provide funding, equipment, or in-kind support for the project identified by the user. Accordingly, the user places environmental project information with the Environmental Project Pipeline System 100 as a result of the process and the specific data criteria resource 120 receives this information that allows for highly-defined targeted marketing and matching efforts to provide funding or resources for the project to be completed. All of this may be accomplished in the convenient, non-intrusive environment of an on-line interaction.

Central station 102 is used to communicate to a specific data criteria resource 120 the users 140A, 140B, and 140C identified environmental projects via an environmental project survey that is completed preferably on-line by the users 140A, 140B, and 140C and stored on a database 112 at the central station 102. These environmental project surveys may include survey questions and answers, and the like related to environmental projects that users 140A, 140B, and 140C have identified and submitted to the central station 102 via the network 150. Central station 102 may then prepare a customized report generated from the existing database of identified and submitted environmental projects for a specific data criteria resource 120.

When users 140A, 140B, and 140C access the environmental project survey, the central station 102 may request demographic information to characterize those users 140A, 140B, and 140C. This information may include name, address, location of environmental project, cost of environmental project, whether a partner or sponsor exists to assist with the costs of the environmental project, scalability of the environmental project, or any other information.

Communication lines 132 may be any type of communication link capable of supporting data transfer. In one embodiment, the communication lines 132 may comprise, alone or in combination, Integrated Services Digital Network (ISDN), Asymmetric Digital Subscriber Line (ADSL), T1 or T3 communication lines, hardwire lines, or telephone links. It will be understood that the communication lines 132 may comprise other suitable types of data communication links. Communication lines 132 may also connect to a plurality of intermediate servers between network 150 and central station 102, users 140A, 140B, and 140C, and specific data criteria resource 120.

In one embodiment, the network 150 may comprise dial access via a telephone link. In this embodiment, central station 102, users 140A, 140B, and 140C, and specific data criteria resource 120 may be remote from each other and located anywhere in the world. In one embodiment, central station 102, users 140A, 140B, and 140C, and specific data criteria resource 120 may connect and communicate with each other via modems and analog or digital communication lines. Moreover, the network 150 may be any interconnection found on any computer network such as a local area network (LAN), a wide area network (WAN), the Internet, or any other communications and data exchange systems created by connecting two or more computers.

One novel aspect of the present Environmental Project Pipeline System 100 is the environmental project survey 200. In general, RFP's used today by resource providers 120 have widely varying fields and requests for information contained within them, from simplified to very complex and in-depth. The RFP's may be tailored to the resource provider's 120 needs or may be a generic RFP used in the industry. Traditionally, these RFP's are organized into sections, such as biographical, project type, etc. The novel environmental project survey 200 is categorized into efficient and meaningful sections, which enable quick entry of highly relevant data, by a user looking for resources for their environmental project. The organization of the environmental project survey 200 keeps a user focused on those sections that are relevant to their project, thereby further enabling efficient entry of relevant and categorized information into the Environmental Project Pipeline System 100. This further allows for efficient subsequent storing and categorization of this information at the central station 102, which further enables efficient matching of the resource provider 120 needs with those of an environmental project.

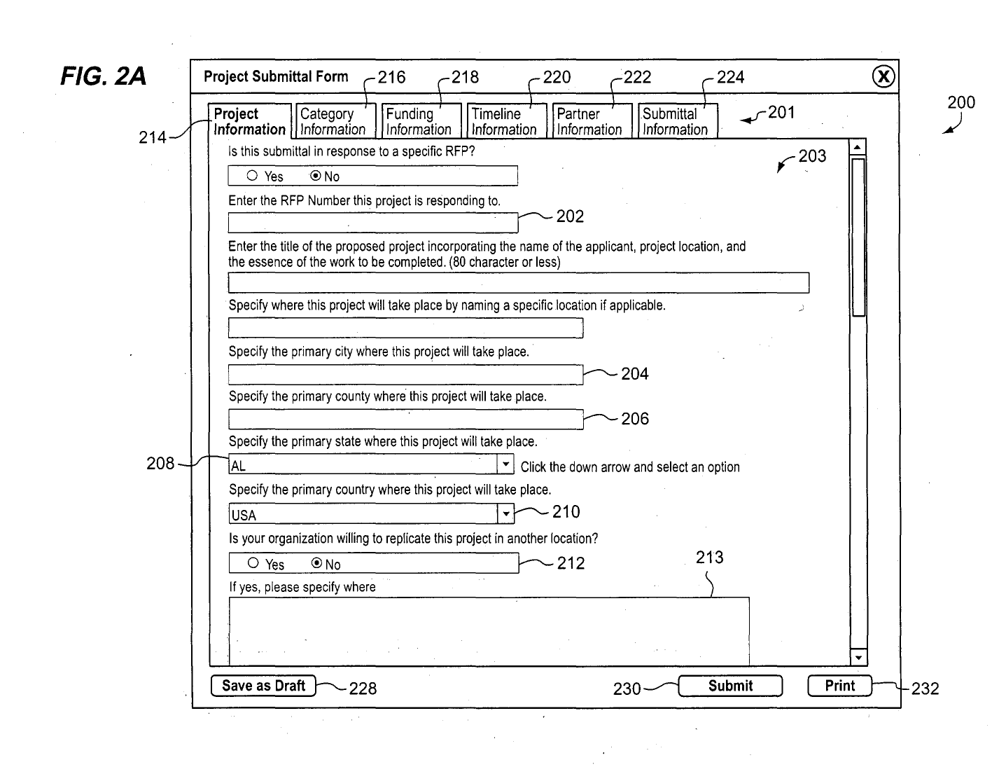

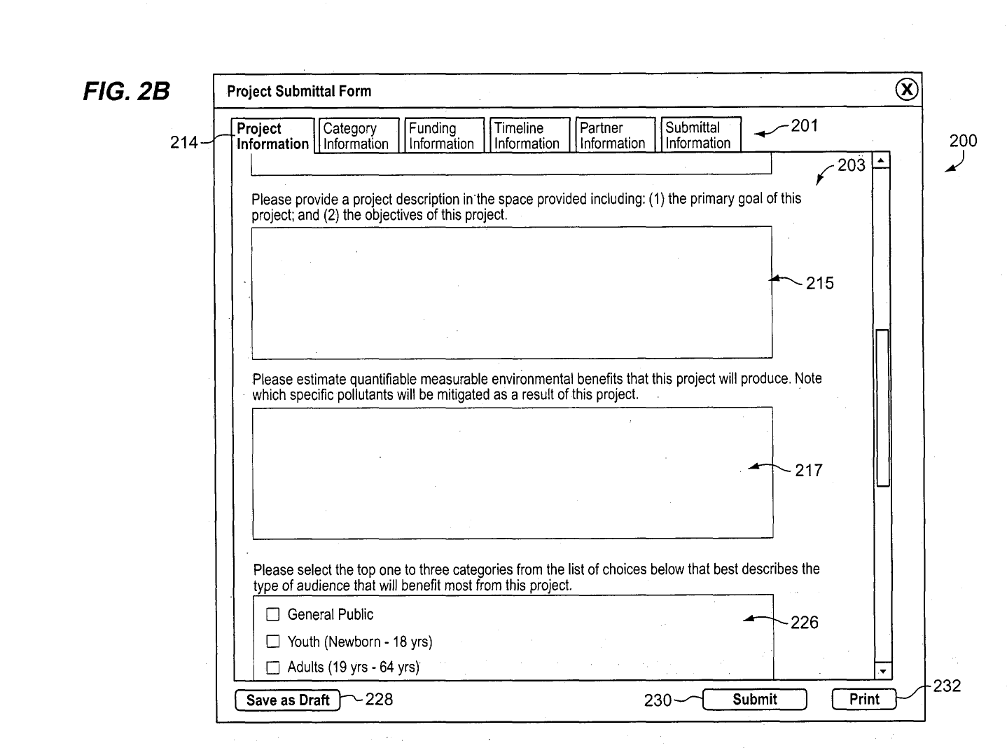

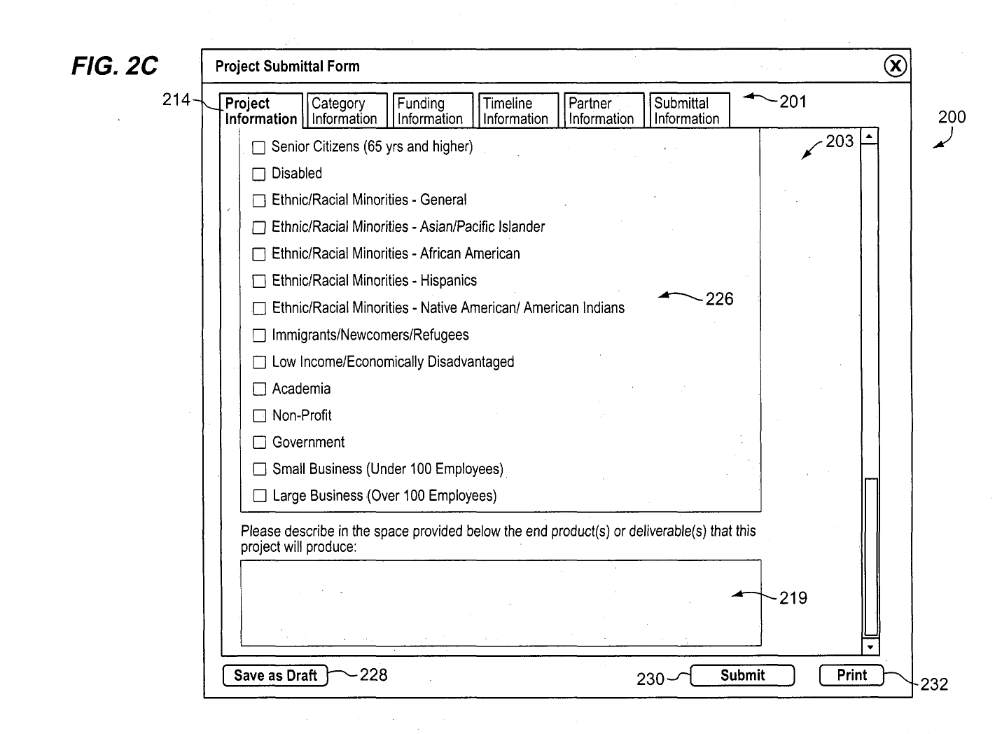

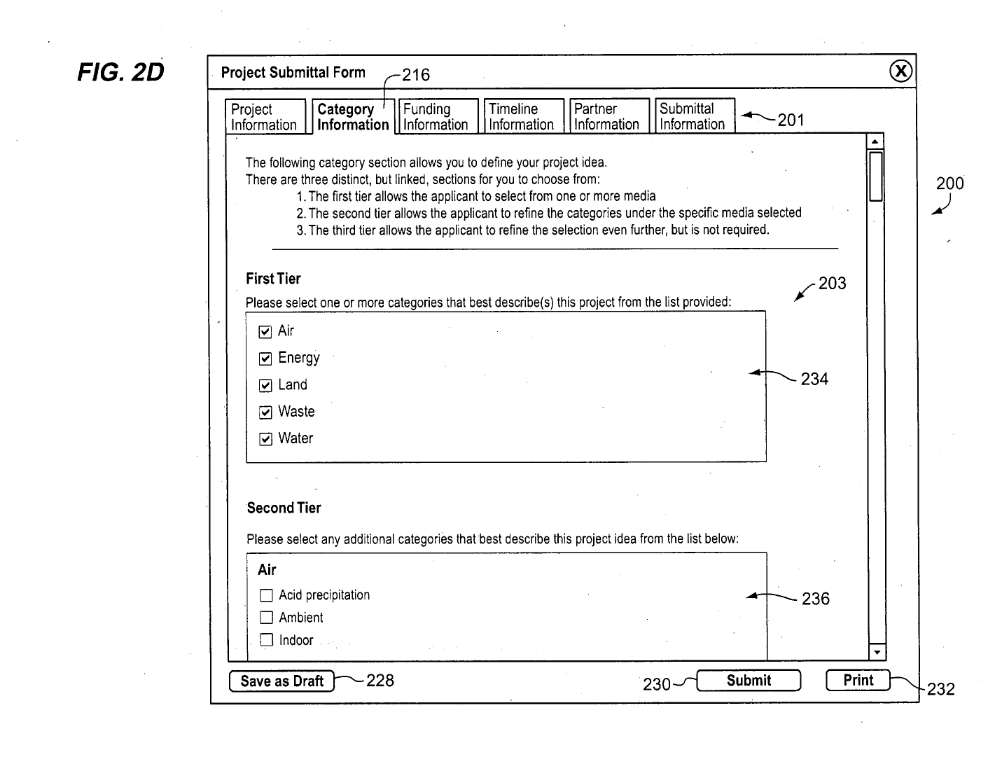

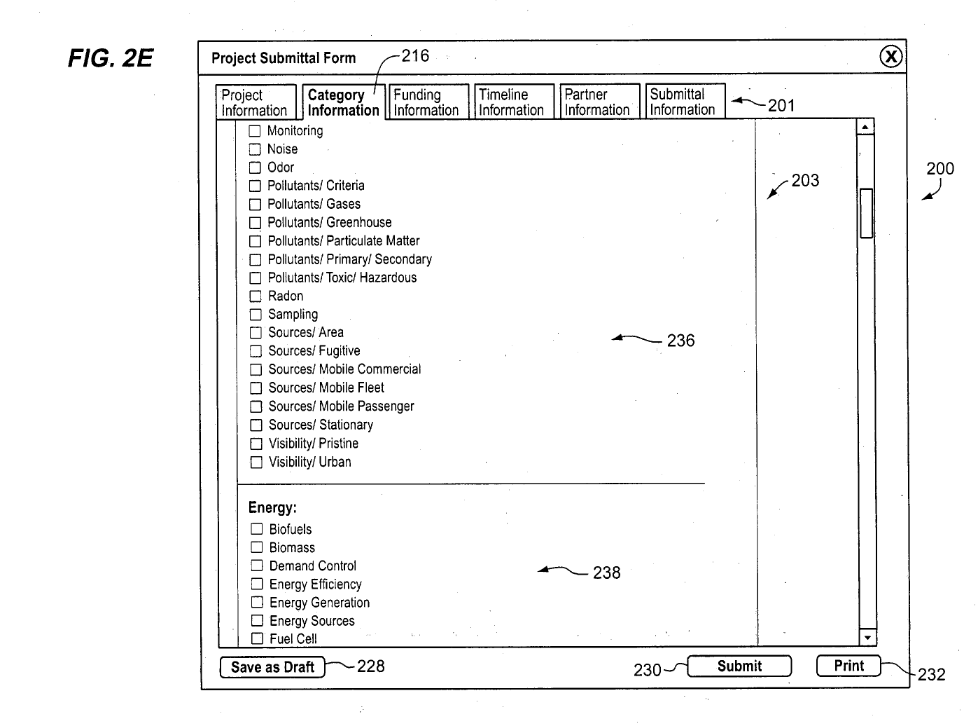

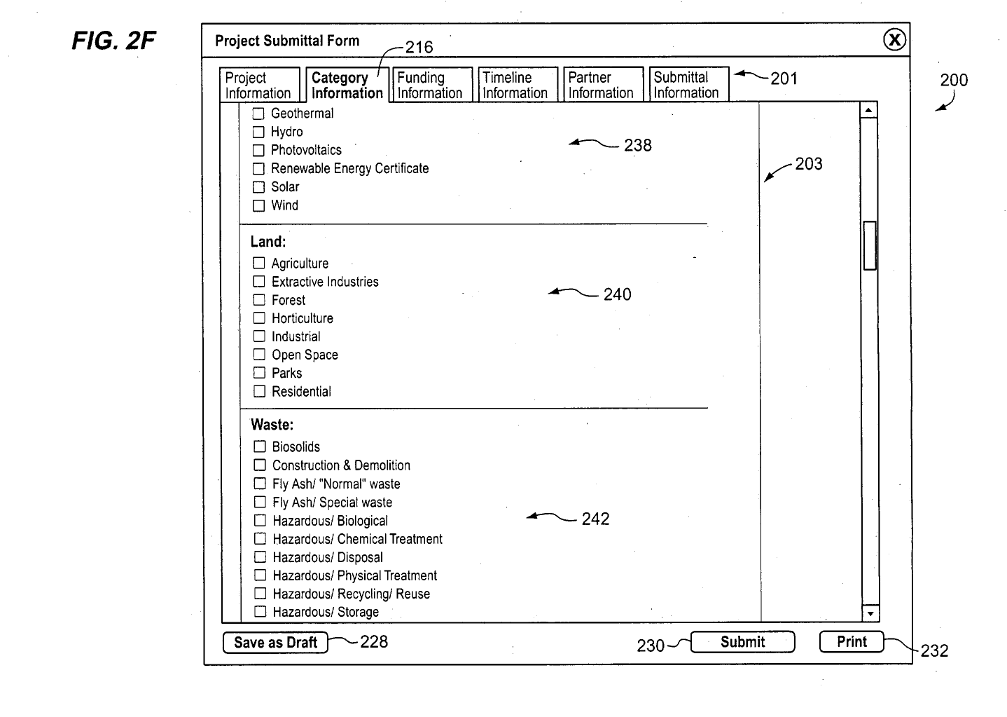

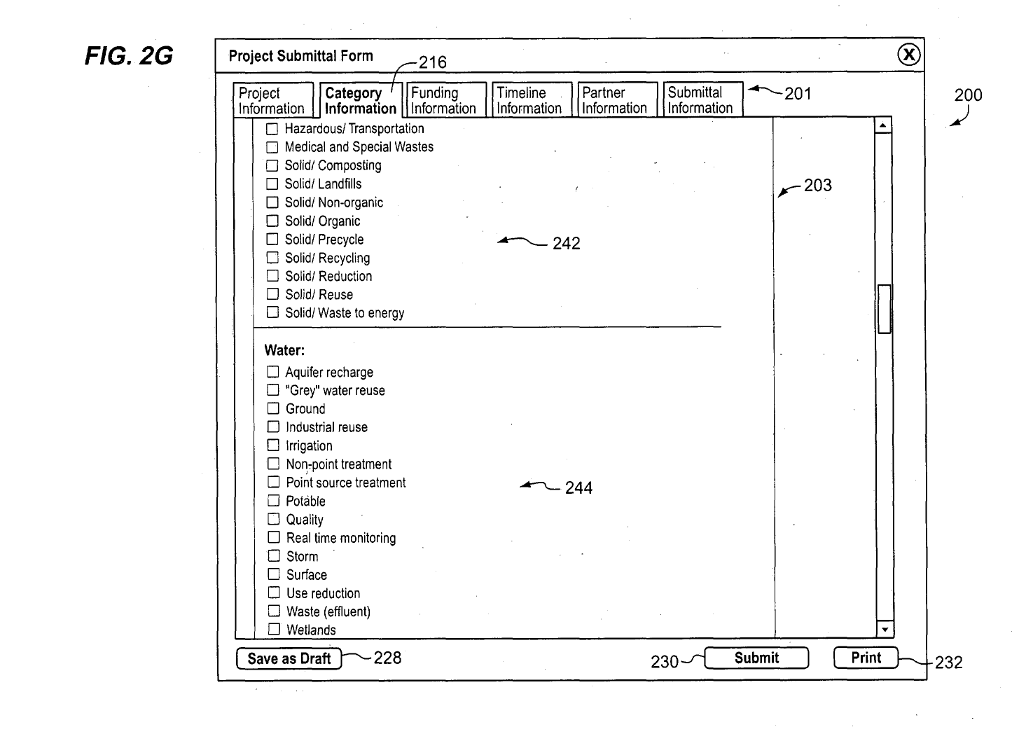

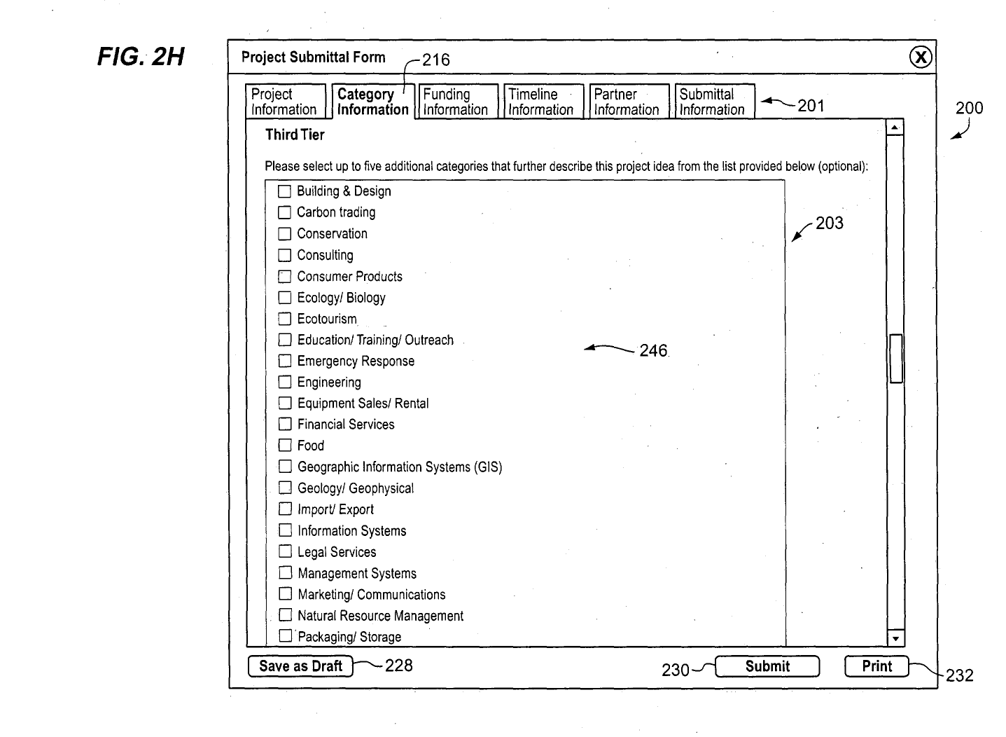

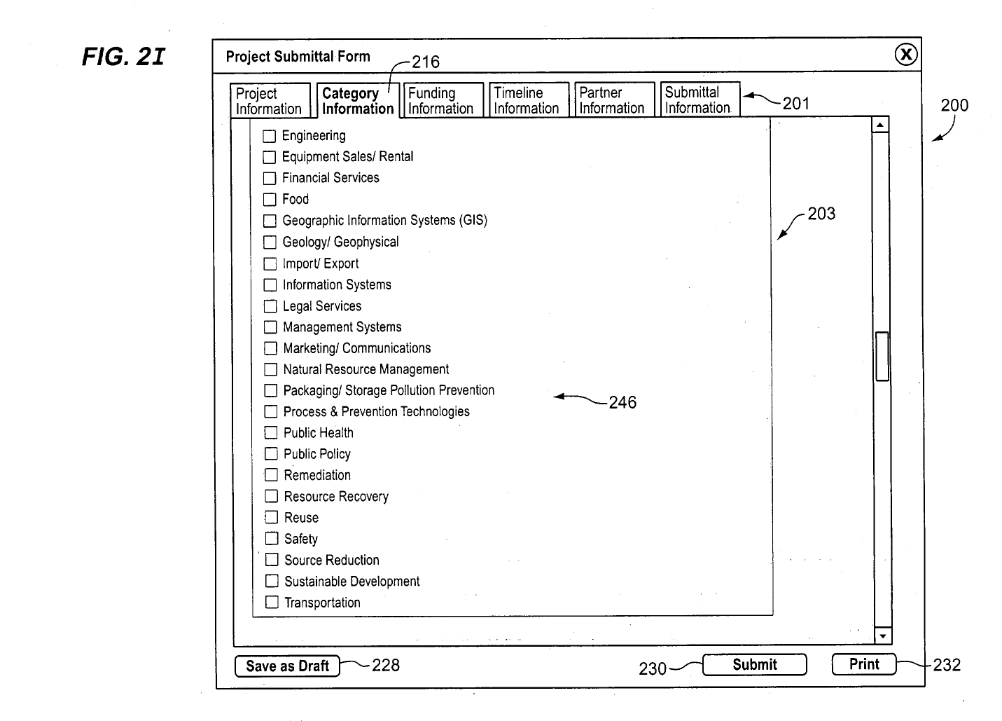

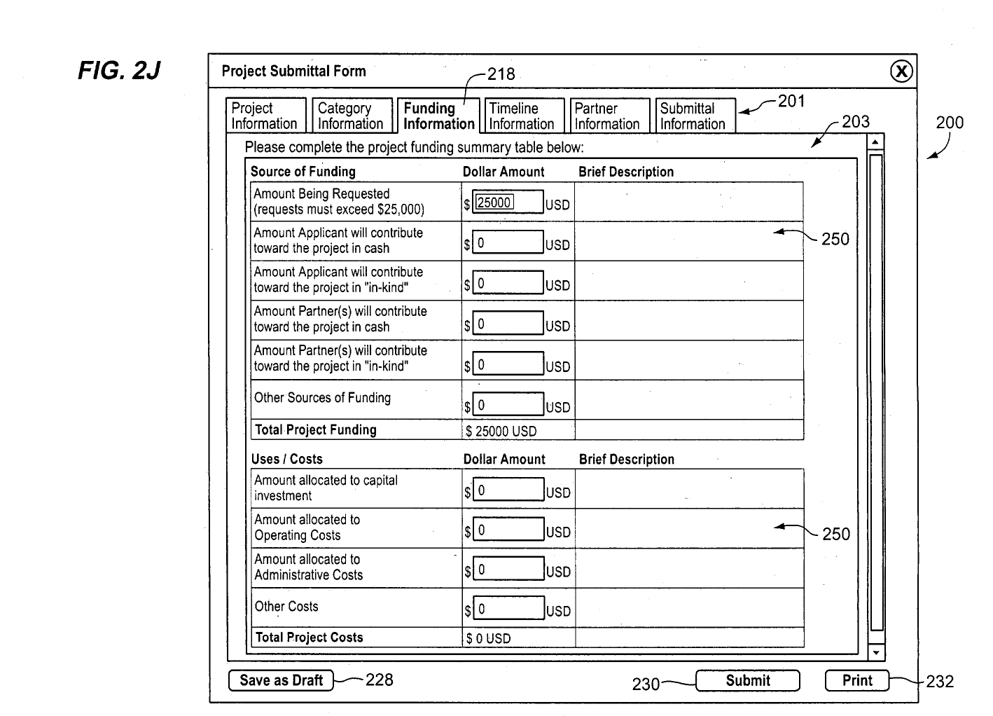

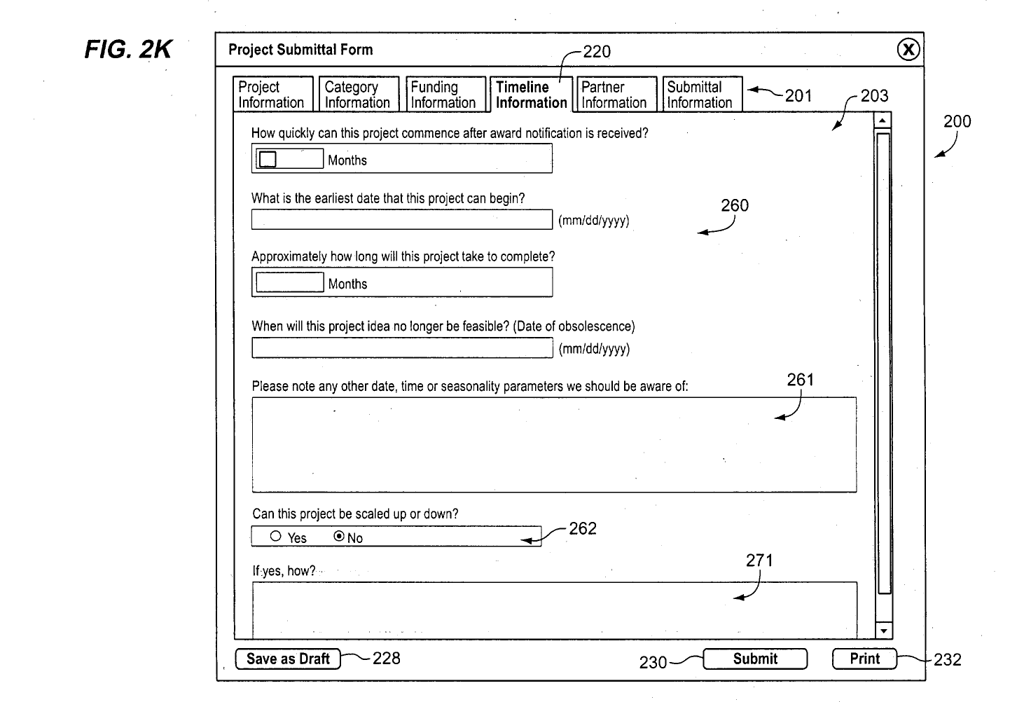

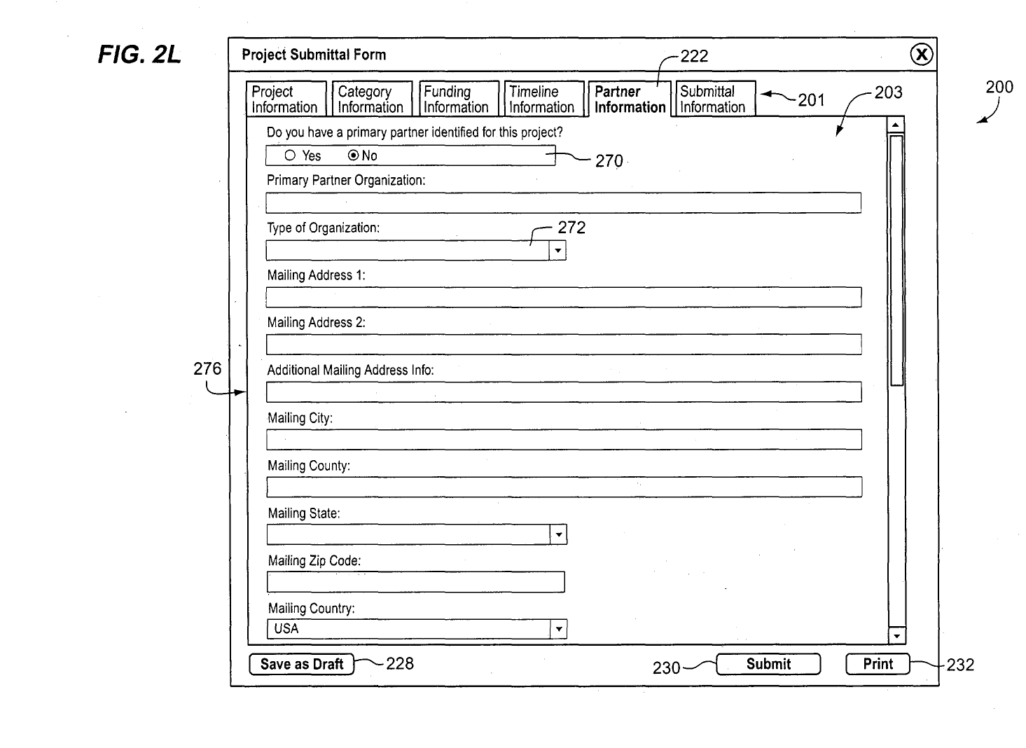

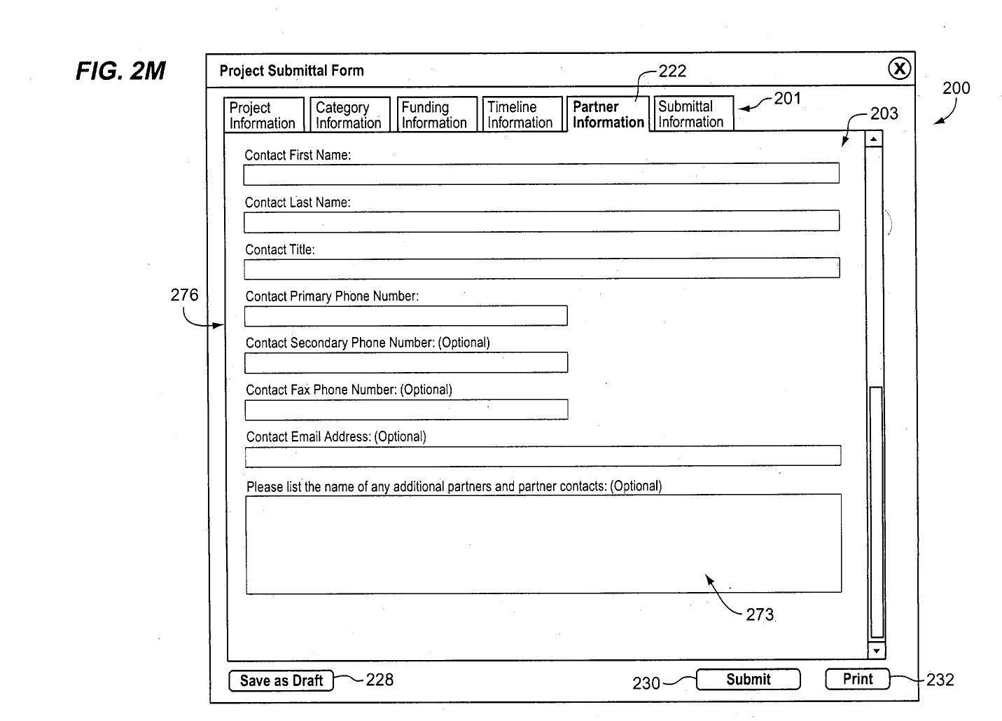

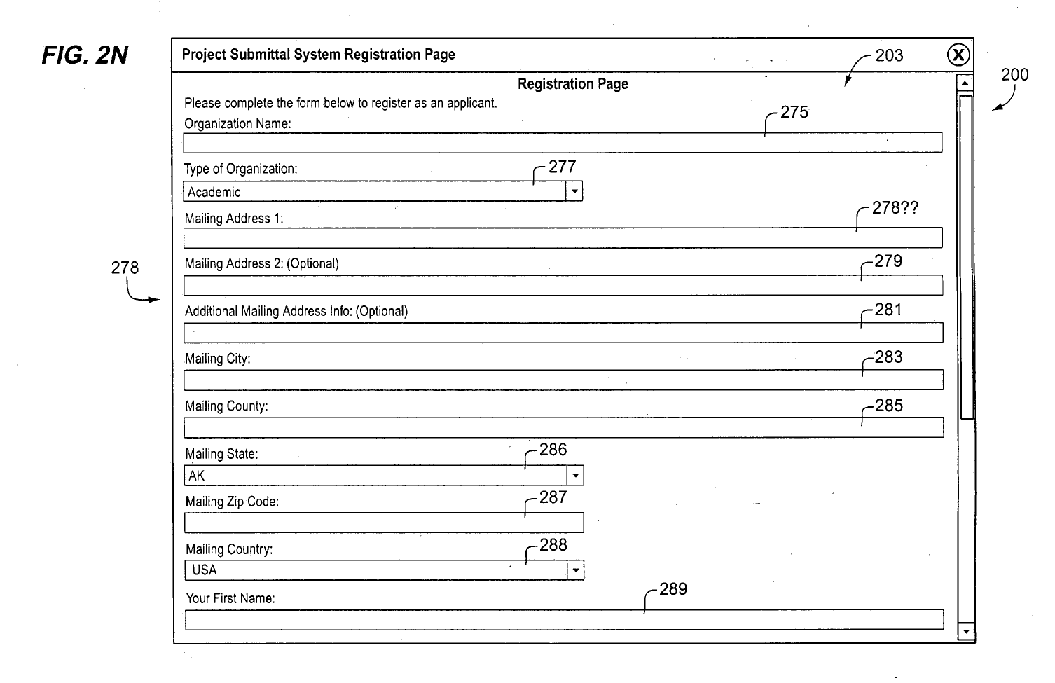

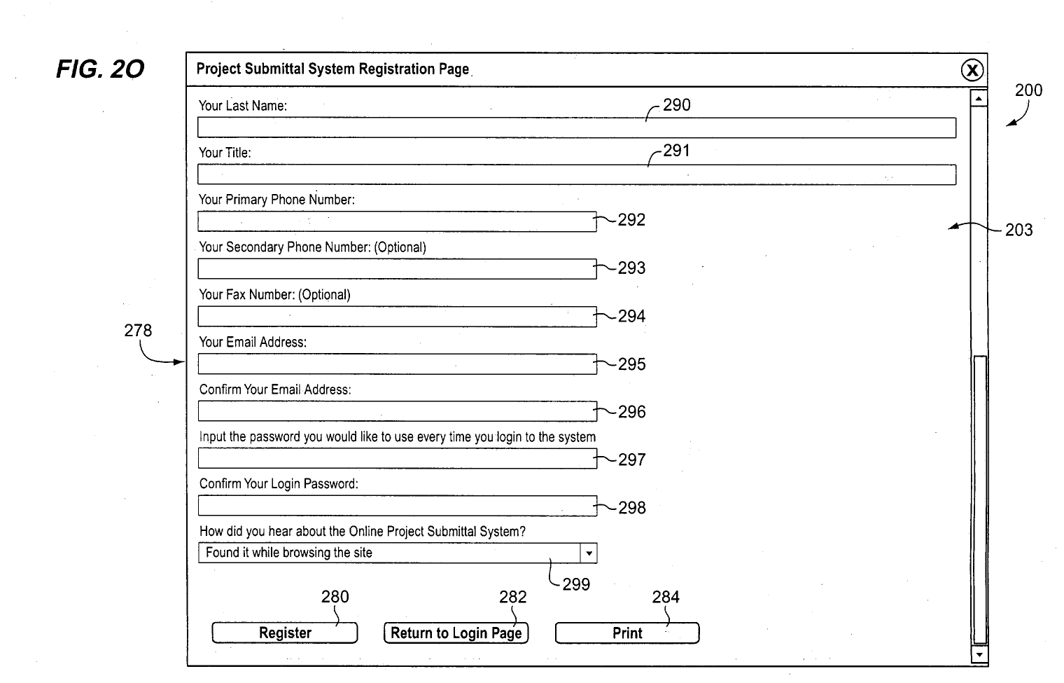

FIG. 2A is a screen shot depicting one embodiment of the environmental project survey 200 presented by central station 102. The environmental project survey 200 is preferably presented in sections that can be navigated among using the section buttons 201, which include project information button 214, category information button 216, funding information button 218, timeline information button 220, partner information button 222, and submittal summary button 224. By selecting any of these section buttons 201, the user is presented with that specific section of the environmental project survey 200. For example, if a user previously entered and saved all selections of an environmental project survey 200 except the partner information section, then the user upon returning to the environmental project survey 200 could select the partner information button 222 and that section would be presented to the user.

In addition, the environmental project survey 200 consists of a plurality of criteria data category 203 that are answered or selected by a user. Among these criteria data category 203 is a request for proposal (RFP) box 202 where a user enters a specific RFP number in which they are applying for resources from. The environmental project survey 200 includes other criteria data category 203, such as project city location box 204 and a project country location box 206. In addition, the criteria data category 203 includes project state drop-down selection box 208, a project country drop-down selection box 210, and a project replication selection 212. If the project replication selection 212 is yes, then the replication text box 213 is enabled to allow a user to type text into the replication text box 213 to further explain the replication details. The environmental project survey 200 further preferably includes a save button 228, a submit button 230, and a print button 232. If the save button 228 is selected by a user, all data that has been entered into the environmental project survey 200 is saved to the central station 102. If the submit button 230 is selected by a user, the environmental project survey 200 is sent to the central station 102 for review. If the print button 232 is selected by a user, the environmental project survey is printed to an output device, such as a printer.

FIG. 2B includes more criteria data category 203 of the environmental project survey 200 project information section, specifically, a primary goal text box 215 and a quantifiable measurable benefit text box 217 to enable a user to enter additional text related to these specific requests. Additional criteria data category 203, includes a project audience check box 226 and a project deliverables text box 219, as shown in FIG. 2C, for further describing the environmental project.

FIG. 2D depicts a screen shot of one embodiment of the category information section of the environmental project survey 200. The category information button 216 is highlighted when this section is displayed. This section preferably includes criteria data category 203, such as first tier check boxes 234. The first tier check boxes 234 preferably include a selection of check boxes of environmental media including air, energy, land, waste, and water. If a user selects or checks the air check box of the first tier check boxes 234, then the Environmental Project Pipeline System displays an air second tier check boxes 236 for a user to enter additional selections regarding the categorization or classification of the user's project. The air second tier check boxes 236 includes such selections as acid precipitation, ambient, indoor, monitoring, noise, odor, pollutants/criteria, pollutants/gases, pollutants/greenhouse, pollutants/particulate matter, pollutants/primary/secondary, radon, sampling, sources/area, sources/fugitive, sources/mobile commercial, sources/mobile fleet, sources/mobile passenger, sources stationary, visibility/pristine, and visibility/urban.

FIG. 2E depicts a screen shot of one embodiment of the category information section of the environmental project survey 200. If a user selects or checks the energy check box of the first tier check boxes 234, then the Environmental Project Pipeline System displays an energy second tier check boxes 238 for a user to enter additional selections regarding the categorization or classification of the user's project. The energy second tier check boxes 238 includes such selections as biofuels, biomass, demand control, energy efficient, energy generation, energy sources, fuel cell, geothermal, hydro, photovoltaics, clean energy certificates, solar, and wind.

FIGS. 2E-2I depict screen shots of one embodiment of the category information section of the environmental project survey 200. If a user selects or checks the land check box of the first tier check boxes 234, then the Environmental Project Pipeline System displays a land second tier check boxes 240 for a user to enter additional selections regarding the categorization or classification of the user's project. The land second tier check boxes 240 includes such selections as agriculture, extractive industries, forest, horticulture, industrial, open space, parks, and residential. If a user selects of checks the waste check box of the first tier check boxes 234, then the Environmental Project Pipeline System displays waste second tier check boxes 242 for a user to enter additional selections regarding the categorization or classification of the user's project. The waste second tier check boxes 242 includes such selections as bio-solids, construction/demolition, fly ash/normal waste, fly ash/special waste, hazardous/biological, hazardous/chemical treatment, hazardous/disposal, hazardous/physical treatment, hazardous/recycling/reuse, hazardous/storage, hazardous/transportation, medical/special wastes, solid/landfills, solid/non-organic, solid/organic, solid/precycle, solid/recycling, solid/reduction, solid/reuse, and solid/waste to energy.

In addition, if a user selects of checks the water check box of the first tier check boxes 234, then the Environmental Project Pipeline System displays a water second tier check boxes 244 for a user to enter additional selections regarding the categorization or classification of the user's project. The water second tier check boxes 244 includes such selections as aquifer recharge, “grey” water reuse, ground, industrial re-use, irrigation, non-point treatment, point source treatment, potable, quality, real time monitoring, storm, surface, use reduction, waste (effluent), and wetlands.

In all cases above, when a user selects or checks any of the first tier check boxes 234, then the Environmental Project Pipeline System displays a third tier check boxes 246 for a user to enter additional selections regarding the categorization or classification of the user's project. The third tier check boxes 246 includes such selections as building/design, carbon trading, conservation, consulting, consumer products, ecology/biology, ecotourism, education/training/outreach, emergency response, engineering, equipment sales/rental, financial services, food, geographic information systems (GIS), geology/geophysical, import/export, information systems, legal services, management systems, marketing/communications, natural resource management, packaging/storage, pollution prevention, process/prevention technologies, public health, public policy, remediation, resource recovery, reuse, safety, source reduction, sustainable development, and transportation.

FIG. 2J depicts a screen shot of one embodiment of the funding information section of the environmental project survey 200. The funding information button 218 is highlighted when this section is displayed. The funding information section includes information related to the sources of funding boxes 250 and total project funding boxes 252 for an environmental project submitted to the central station 102 by a user. The funding boxes 250 include information such as, amount being requested, amount applicant will contribute toward the project in cash, amount applicant will contribute toward the project “in-kind,” amount partners will contribute toward the project in cash, and amount partners will contribute toward the project “in-kind.” The total project funding boxes 252 include information, such as amount allocated to capital investment, amount allocated to operating costs, amount allocated to administrative costs, and other costs.

FIG. 2K depicts a screen shot of one embodiment of the timeline information section of the environmental project survey 200. The timeline information button 220 is highlighted when this section is displayed. The timeline information section includes timeline information boxes 260 to enable the user to quickly enter timeline data related to the user's environmental projects. These timeline information boxes 260 preferably include the time the project can commence, earliest starting date, duration of the environmental project, and date that the environmental project is no longer feasible. The timeline information section further includes a seasonality text box 261, a scalability selection box 262, and a scalability text box 271.

FIGS. 2L-2M depict screen shots of one embodiment of the partner information section of the environmental project survey 200. The partner information button 222 is highlighted when this section is displayed. The partner information section includes information related to a partner or sponsor the user has in relation to the user's environmental project. The partner information section includes a primary partner selection 270 and text box to type in the partner's name. Further, this section includes a type of organization drop-down selection box 272, which lists a typical or common organization type, including business, government, non-government, and academic types. In addition, the partner information section includes general partner information boxes 276, such as mailing address1, mailing address2, additional mailing address information, mailing city, mailing county, mailing state, mailing zip code, mailing country, contact first name, contact last name, contact title, contact primary phone number, contact secondary phone number, contact fax number, contact email address, and an additional partner text box 273 for including the names of additional partners of the environmental project.

FIGS. 2N-2O depict screen shots of one embodiment of the user registration information section of the environmental project survey 200. The user registration information section includes general user information 278 about a user submitting an environmental project to the Environmental Project Pipeline System 100. For example, the user registration information section includes organization name box 275, a type of organization drop-down selection box 277, mailing address1 box 278, mailing address2 box 279, additional mailing address information box 281, mailing city box 283, mailing county box 285, mailing state pull-down selection box 286, mailing zip code 287, mailing country box 288, user first name box 289, user last name box 290, user title box 291, user primary phone number box 292, user secondary phone number box 293, user fax number box 294, user email address box 295, user email confirmation box 296, user password input box 297, user password confirmation box 298, and user marketing pull-down selection box 299.

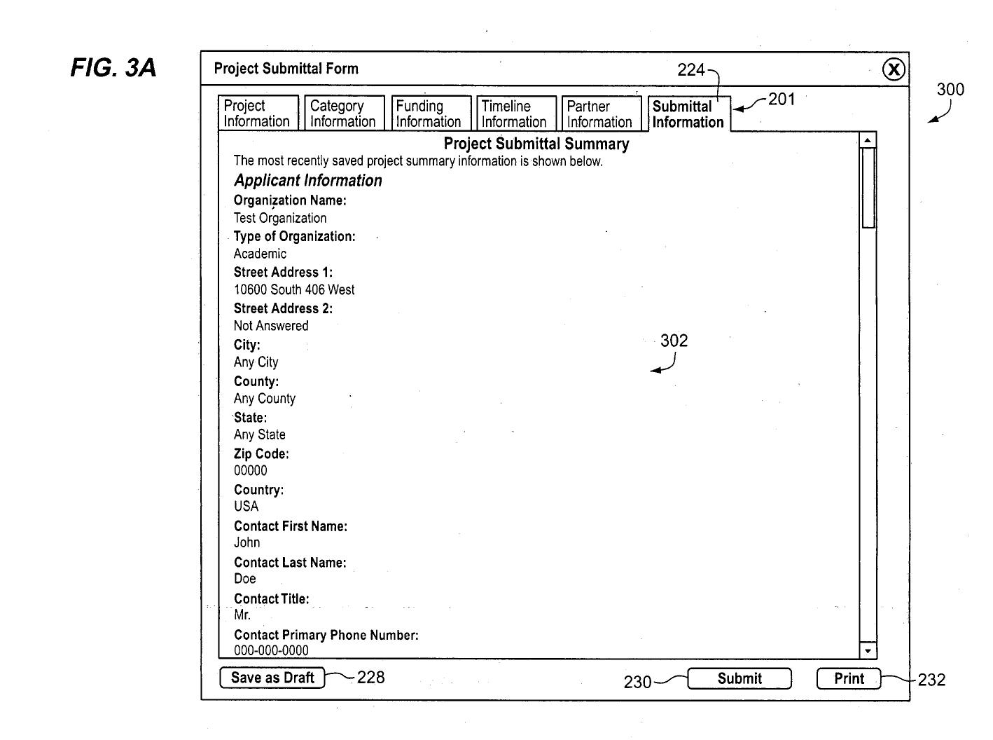

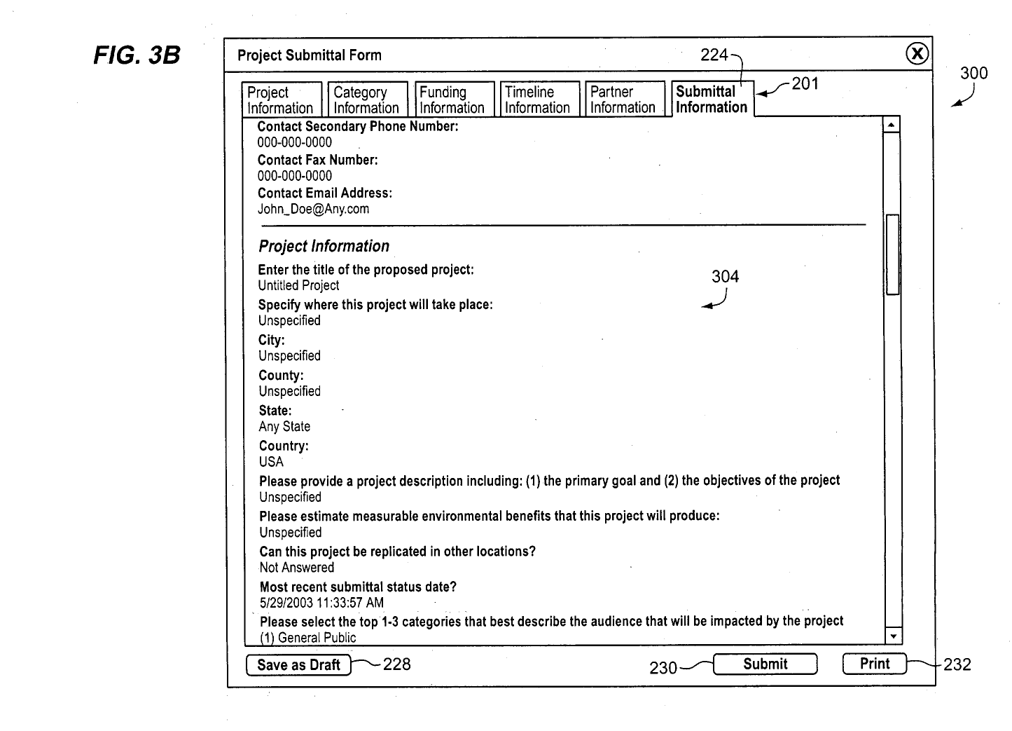

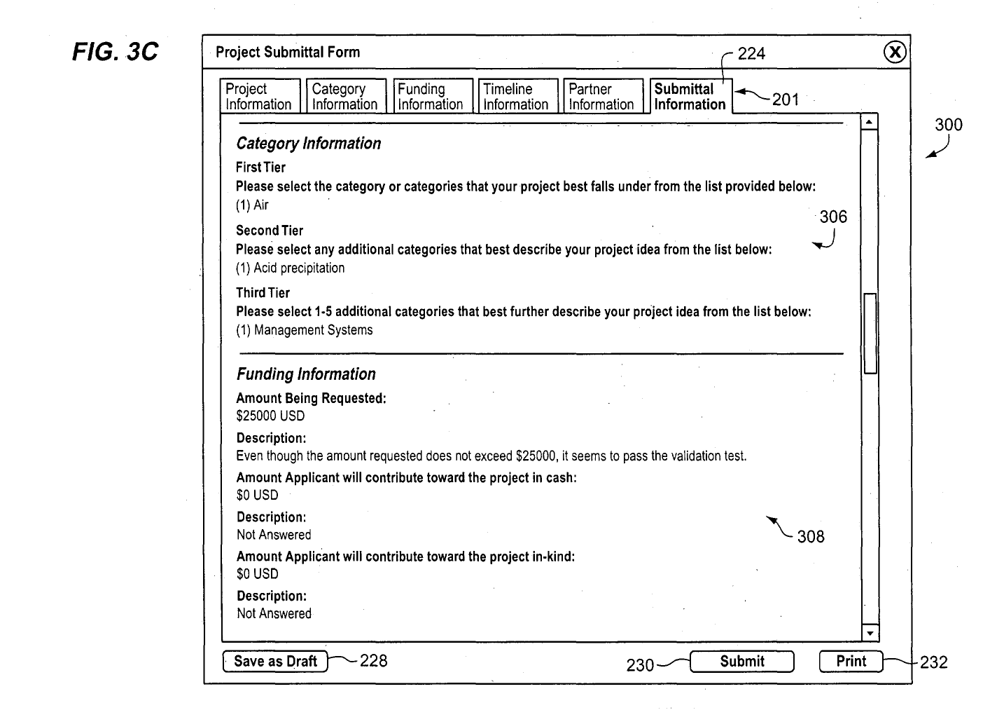

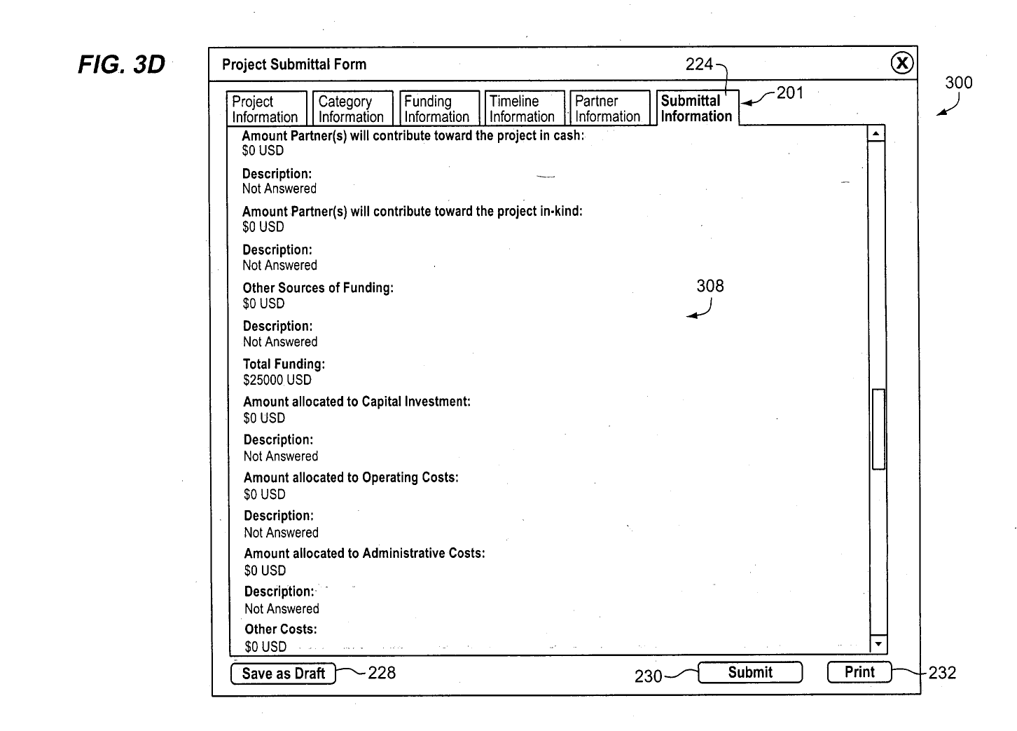

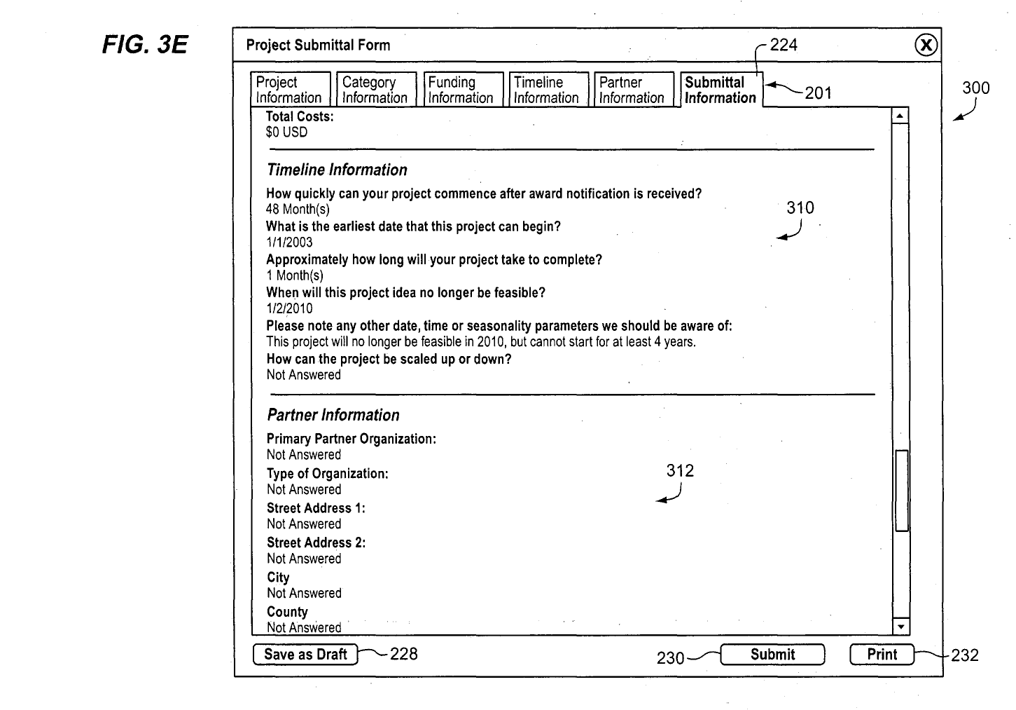

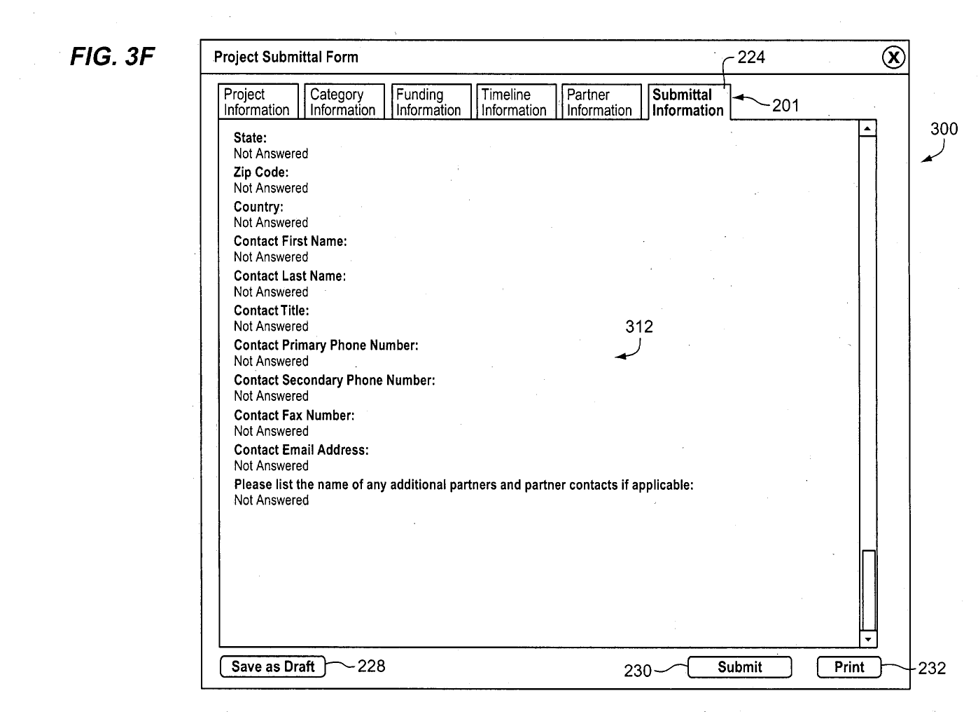

FIGS. 3A-3F depict screen shots of one embodiment of the submittal summary section of the environmental project survey 200. The submittal summary button 224 is highlighted when this section is displayed. This section displays to a user a submittal summary 300 of the environmental project survey 200 that the user has completed. This is useful, in that it allows a user to see a submittal summary 300 of their selections on the environmental project survey 200 prior to submitting the environmental project survey 200 to the central station 102 of the Environmental Project Pipeline System 100. The submittal summary 300 preferably summarizes and displays to a user applicant information 302, project information 304, category information 306, funding information 308, timeline information 310, and partner information 312.

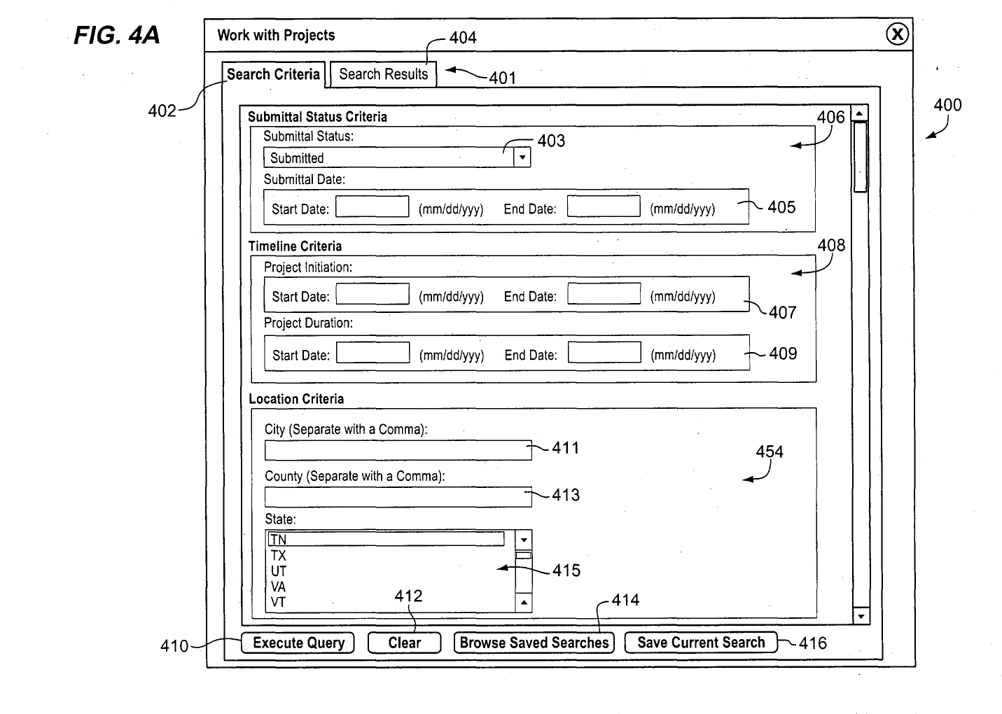

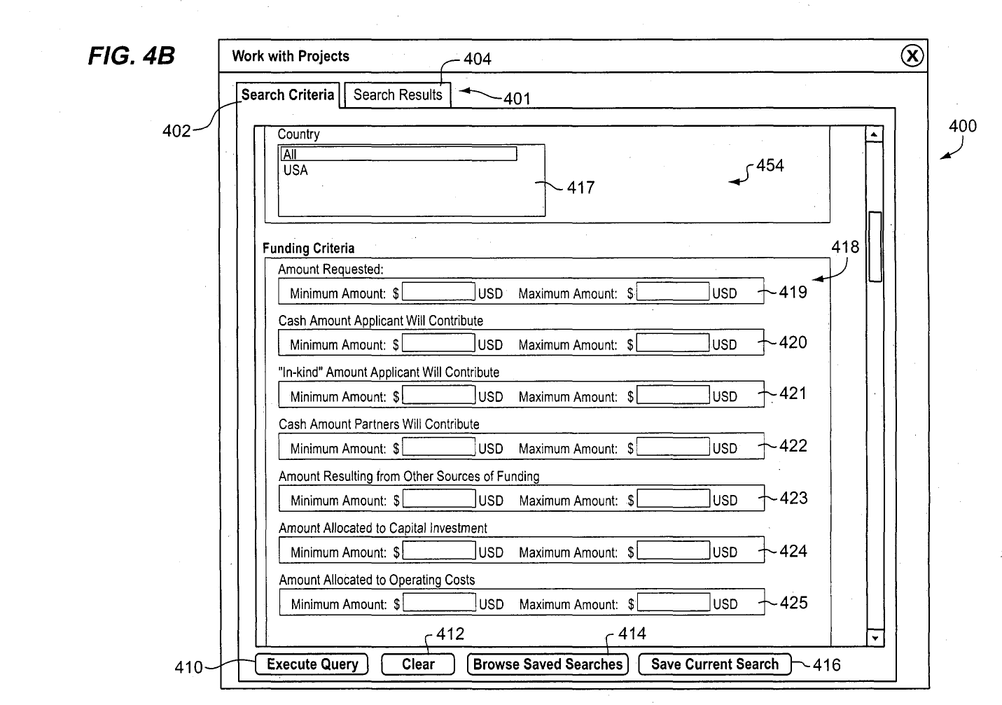

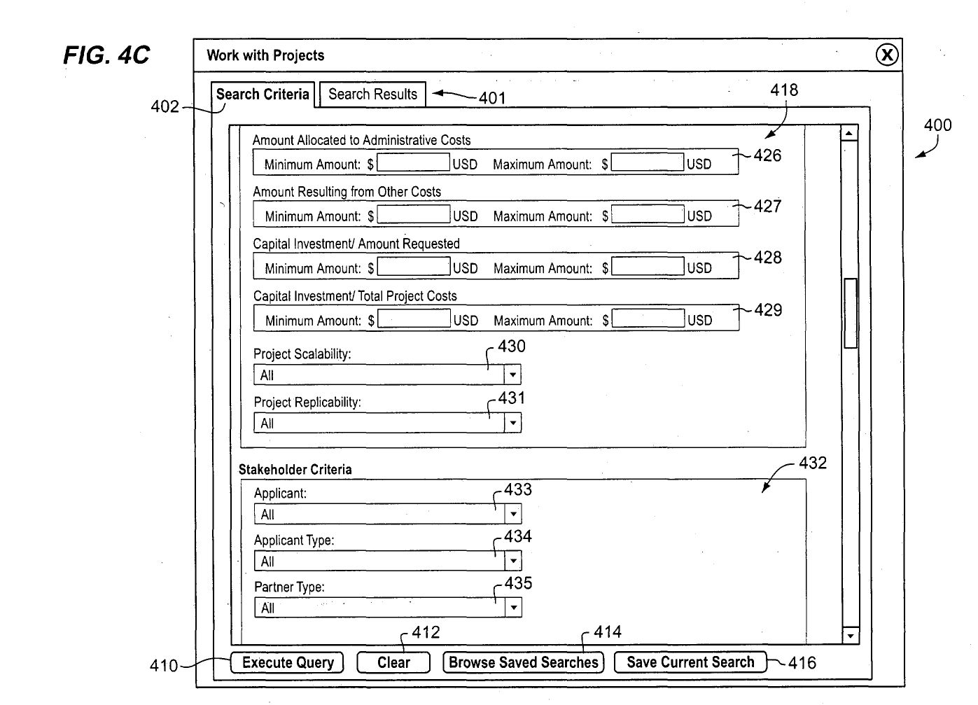

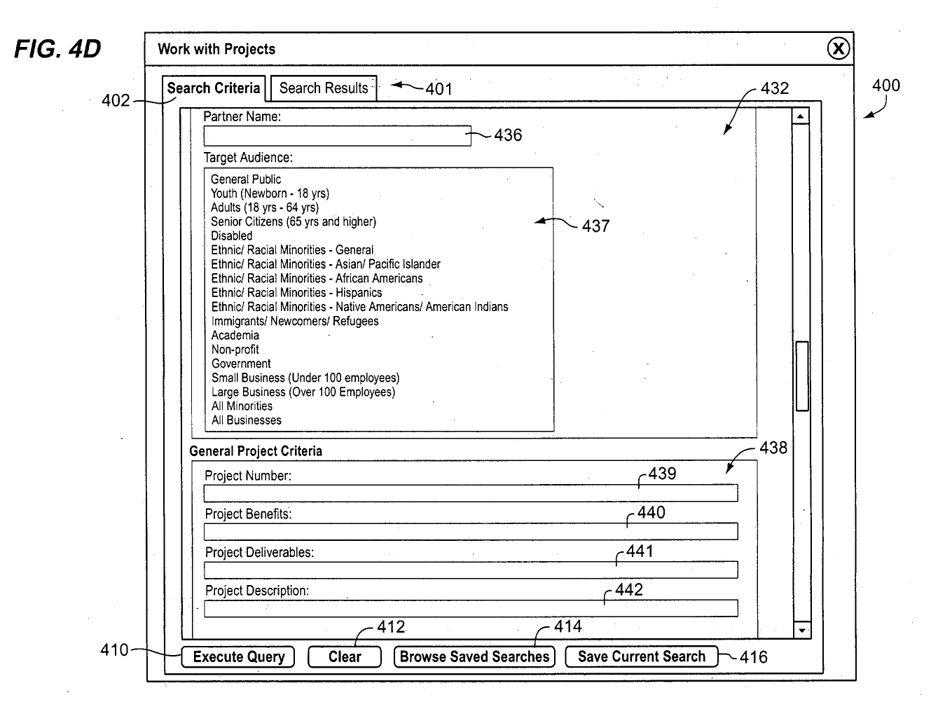

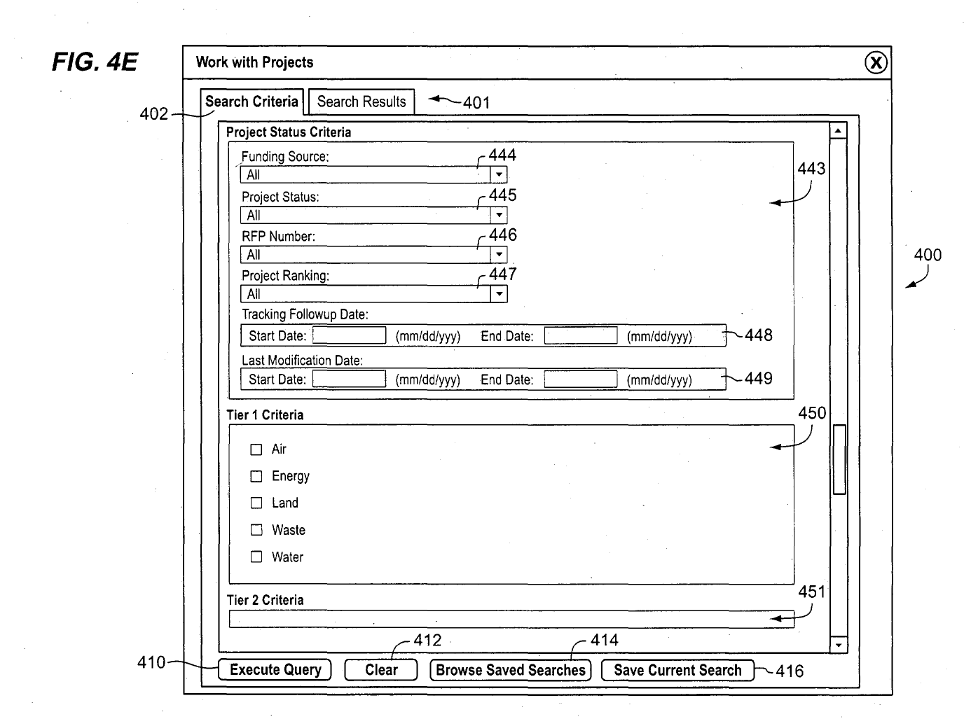

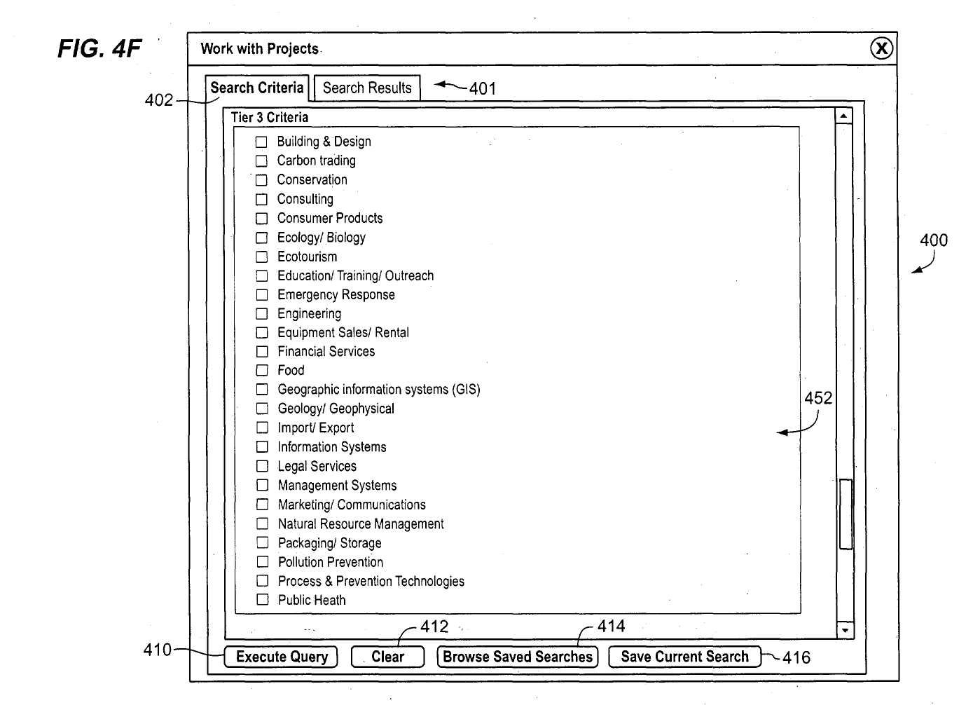

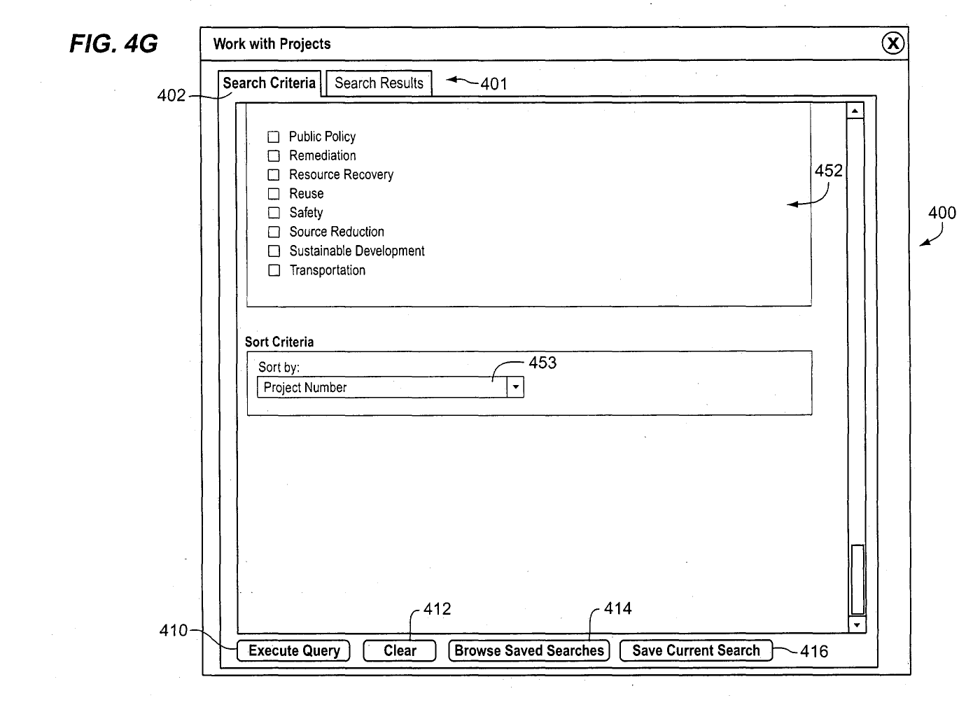

FIGS. 4A-4G depict screen shots of one embodiment of a projects search form 400 of the Environmental Project Pipeline System 100. The search criteria button 402 is highlighted when this section is displayed. The search section of the Environmental Project Pipeline System 100 includes buttons 401 in which to navigate between these two search areas. This section of the Environmental Project Pipeline System 100 is utilized by the central station 102 to generate reports for matching stored environmental project surveys submitted by users with resource providers. The projects search form 400 includes submittal status criteria section 406 which includes submittal status drop-down selection box 403 and a submittal date selection box. In addition, the projects search form 400 includes a timeline criteria section 408, which includes project initiation box 407 and a project duration box 409. Furthermore, the projects search form 400 includes a location criteria section 410, which includes a city selection box 411, a county selection box 413, a state selection box 415, and a country selection box 417. The projects search form 400 preferably further includes an execute query button 410, a clear button 412, a browse saved searches button 414, and a save current search button 416. Once the criteria has been selected that is to be searched among the stored environmental project surveys, a user selects or checks the execute query button 410 and the Environmental Project Pipeline System searches the database 112 to find all of the submitted and stored environmental project surveys to match those with the same selected search criteria. If a user wishes to clear all of the search selections that they have selected, then they would select the clear button 412. The browse saved searches button 414 when selected by a user, displays all of the previous saved searches stored in the database 112. The save current search button 416 is selected when a user wishes to save the current search to the database 112.

The projects search form 400 also includes a funding criteria section 418 which includes an amount requested selection box 419, a cash amount applicant will contribute selection box 420, an “in kind” amount applicant will contribute selection box 421, a cash amount partners will contribute selection box 422, an amount resulting from other sources of funding selection box 423, an amount allocated to capital investment selection box 424, an amount allocated to operating costs selection box 425, an amount allocated to administrative costs selection box 426, an amount resulting from other costs selection box 427, a capital investment amount requested selection box 428, a capital investment/total project costs selection box 429, a project scalability selection box 430, and a project replicability selection box 431. Preferably, the projects search form 400 includes a stakeholder criteria section 432 which includes an applicant drop-down selection box 433, an applicant type drop-down selection box 434, a partner type drop-down selection box 435, a partner name text box 436, and a target audience selection box 437. Also, the projects search form 400 preferably includes a general project criteria section 438 which includes a project number text box 439, a project benefits text box 440, a project deliverables text box 441, and a project description text box 442.

The projects search form 400 also preferably includes a project status criteria section 443 which includes a funding source drop-down selection box 444, a project status drop-down selection box 445, a RFP number drop-down selection box 446, a project ranking drop-down selection box 447, a tracking follow-up date selection box 448, and a last modified date selection box 449. In addition, the projects search form 400 may preferably include a first tier criteria selection which includes check boxes for air, energy, land, waste, and water and it also includes a second tier text check boxes 451 and a third tier selection boxes 452 including building & design, carbon trading, conservation, consulting, consumer products, ecology/biology, ecotourism, education/training/outreach, emergency response, engineering, equipment sales/rental, financial services, food, geographic information systems (GIS), geology/geophysical, import/export, information systems, legal services, management systems, marketing/communications, natural resource management, packaging/storage, pollution prevention, process/prevention technologies, public health, public policy, remediation, resource recovery, reuse, safety, source reduction, sustainable development, transportation, and a sort criteria drop-down selection box 453.

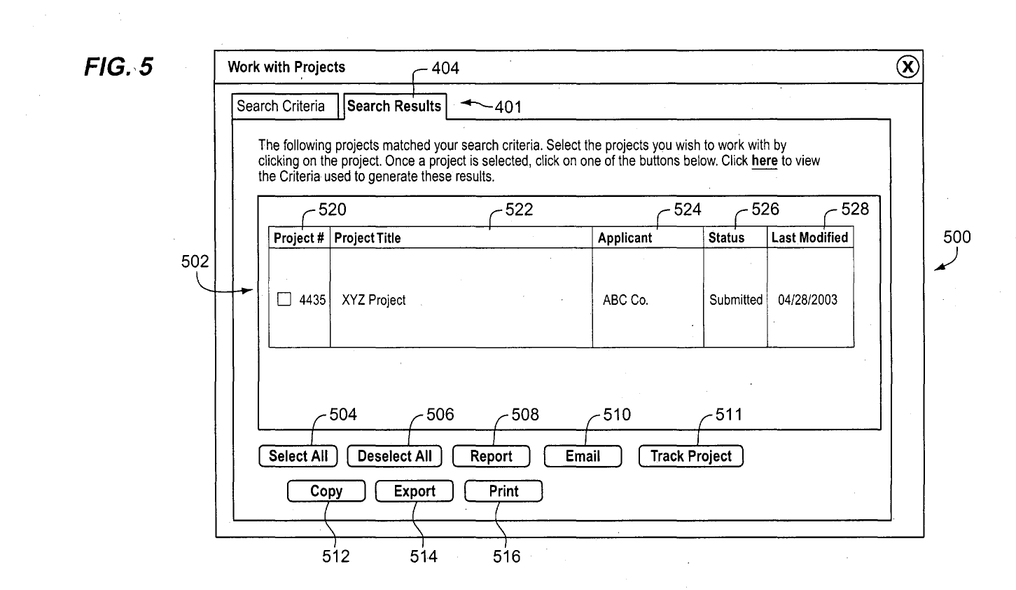

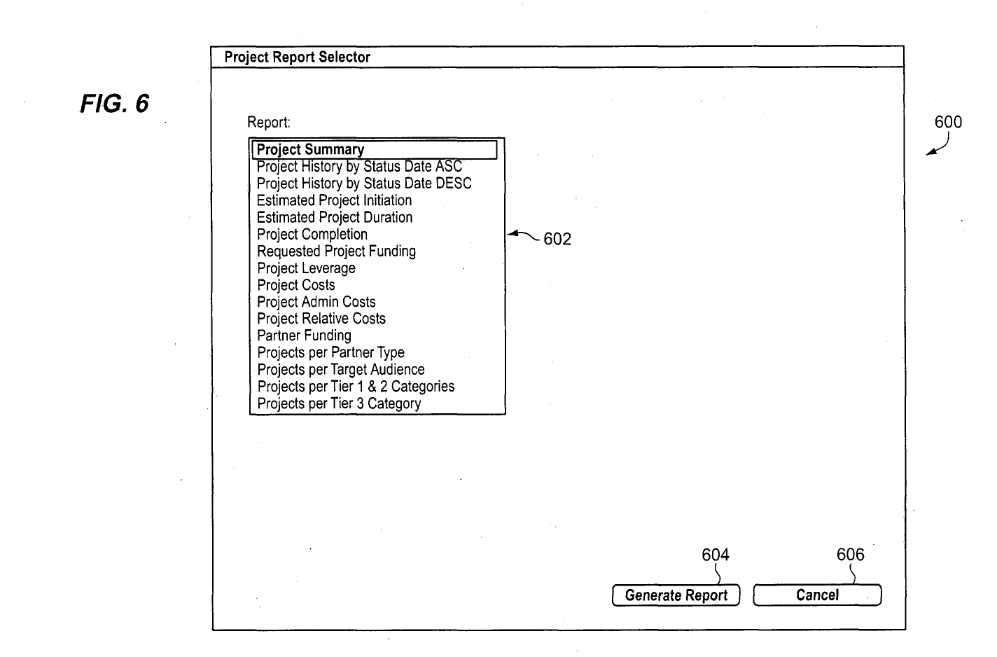

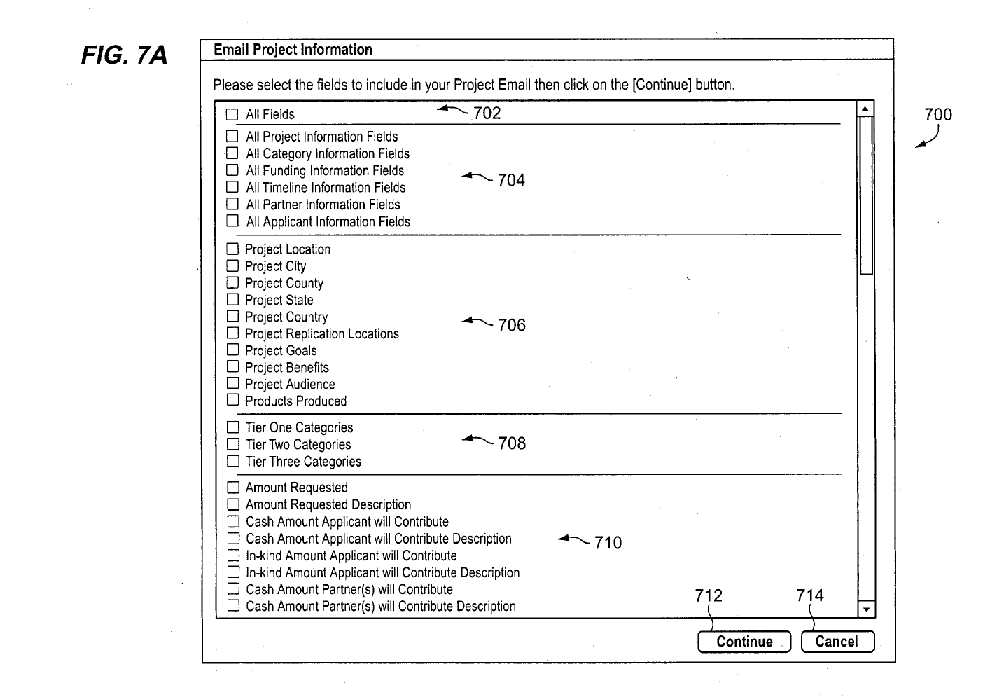

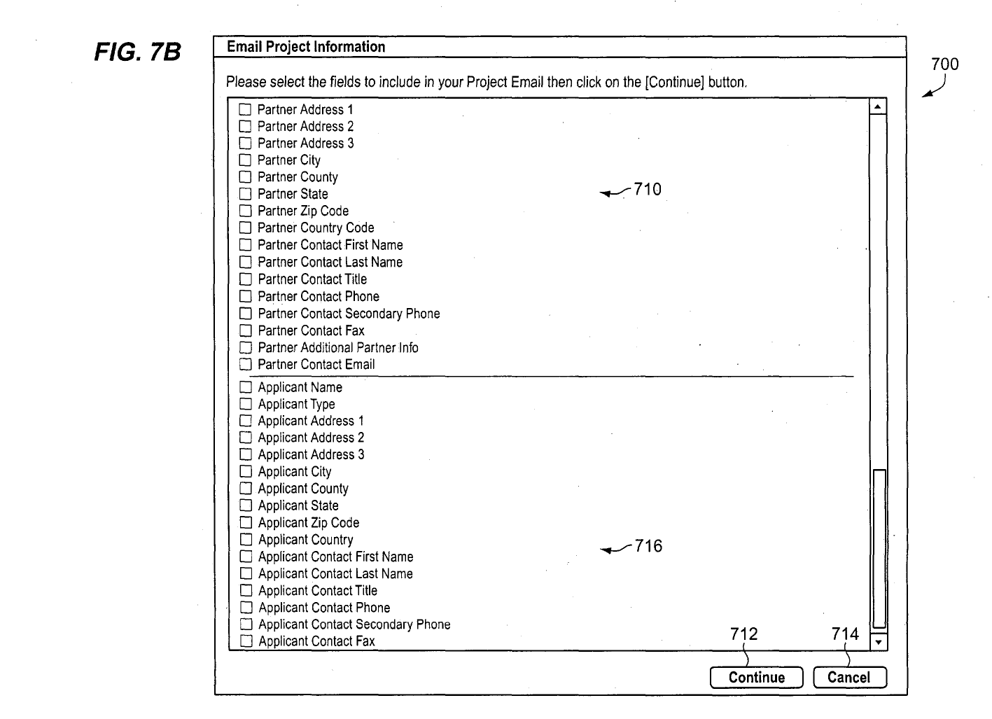

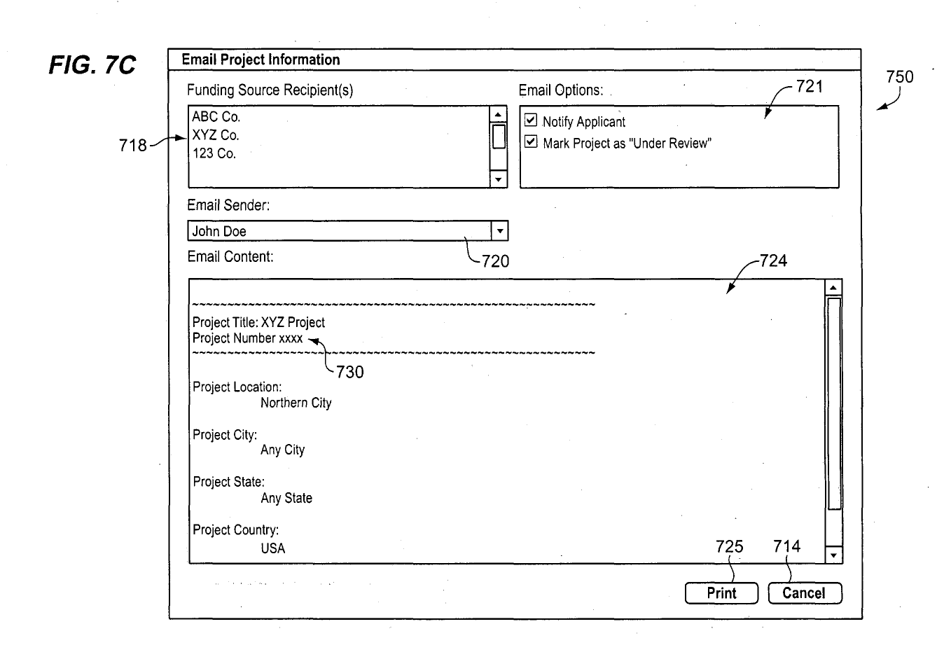

FIG. 5 depicts a screen shot of one embodiment of the search results report 500 of the Environmental Project Pipeline System 100. Preferably, the search results button 404 is highlighted when this report is displayed. The search results report includes those environmental projects surveys that have matching criteria with that selected on the projects search form 400. The search results report 500 is displayed when a user selects some or all of the criteria displayed on the projects search form 400 and then selects the execute query button 410 of projects search form 400. In one embodiment of the search results report 500, several columns are displayed to the user including a project number column 520, a project title column 522, an applicant column 524, a status column 526, and a last modified column 528. Preferably, the search results report 500 includes a select all button 504, a deselect all button 506, a report button 508, an email button 510, a track project button 511, a copy button 512, an export button 514, and a print button 516. The select all button 504 selects all of the displayed projects in the search results report 500. The deselect all button 506 deselects all of the projects displayed in the search results report 500. The report button 508, when selected, displays a project report selector form 600 as in FIG. 6, which will be described in more detail below. The email button 510, when selected, displays an email project information display 700 as in FIGS. 7A-7C, which will be described in more detail below.

FIG. 6 depicts a screen shot of one embodiment of a project selector form 600 of the Environmental Project Pipeline System 100. The project selector form 600 preferably includes a report selector box 602, a generate report button 604, and a cancel button 606. A user may select which criteria data category they wish to be included in a report by selecting the desired criteria data category in the report selector box 602 and then selecting the generate report button 604. One or more of the criteria data category displayed in the report selector box 602 may be selected.

FIGS. 7A-7C depict screen shots of one embodiment of an email project information display 700 of the Environmental Project Pipeline System 100. The email project information display 700 preferably includes check boxes to enable a user to quickly select those criteria data category that they wish to include in an email to a resource provider. The email project information display 700 includes an all fields check box 702, which when selected selects all of the criteria data fields displayed to a user on the email project information display 700. In addition, the email project information display 700 preferably includes check boxes 704 for such criteria data category as all project information fields, all category information fields, all funding information fields, all timeline information fields, all partner information fields, and all applicant information fields. Also, email project information display 700 includes check boxes 706 for such criteria data category as project location, project city, project county, project state, project country, project replication locations, project goals, project benefits, project audience, and project produced. Other check boxes 708 preferably included on the email project information display 700 include such criteria data category as tier one categories, tier two categories, and tier three categories, plus check boxes 710 such as amount requested, amount requested description, cash amount applicant will contribute, cash amount applicant will contribute description, in-kind amount applicant will contribute, in-kind amount applicant will contribute description, cash amount partner(s) will contribute, cash amount partner(s) will contribute description, in-kind partner(s) will contribute, partner address2, partner address3, partner city, partner county, partner state, partner zip code, partner country code, partner contact first name, partner contact last name, partner contact title, partner contact phone, partner contact secondary phone, partner contact fax, partner additional partner information, and partner contact email.

In addition, the email project information display 700 preferably includes a continue button 712 and a cancel button 714. When the continue button 712 is selected the Environmental Project Pipeline System 100 displays an email recipient form 750 as depicted in FIG. 7C. When the cancel button 714 is selected the Environmental Project Pipeline System 100 cancels the email project information function and returns the user back to the previous page. The email project information display 700 also preferably includes check boxes 716 related to applicants general information, including applicant name, applicant type, applicant address1, applicant address2, applicant address3, applicant city, applicant county, applicant state, applicant zip code, applicant country, applicant contact first name, applicant last name, applicant contact title, applicant contact phone, applicant contact secondary phone, applicant contact fax, and applicant contact email address. The email recipient form 750 includes a funding source recipient selection box 718, an email options selection box 721, an email sender drop-down selection box 720, and an email contents box 724. The email contents box 724 preferably includes those criteria data category that is selected in the email project information display 700, such as project number 730. The email recipient form 750 preferably includes a print button 725 for printing the email recipient form 750 before it is sent to the recipients.

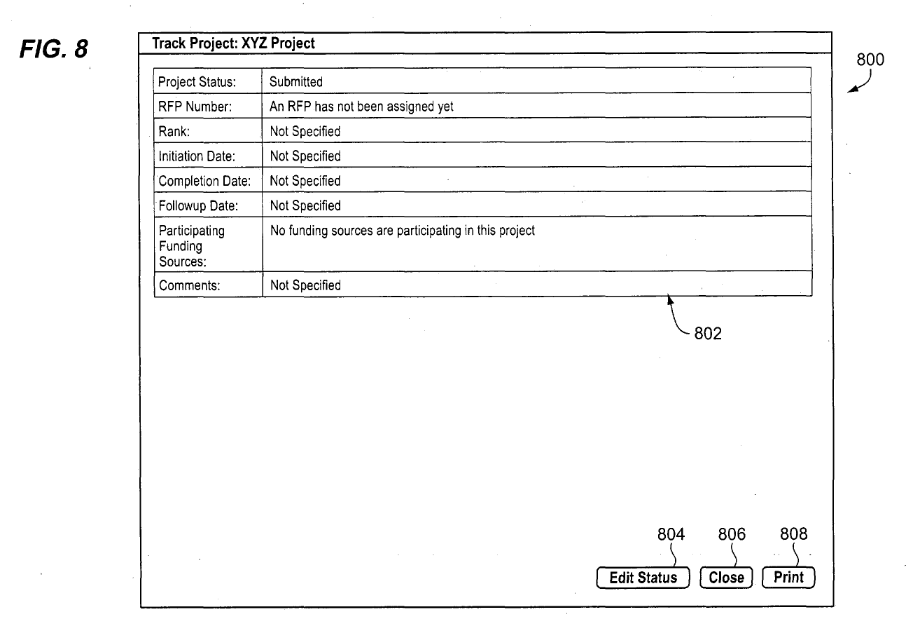

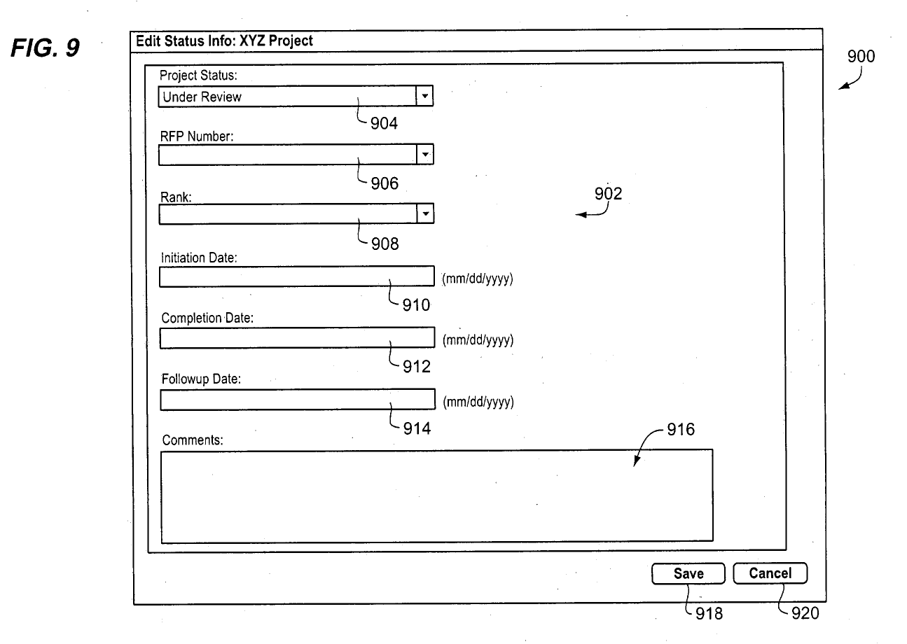

FIG. 8 depicts a screen shot of one embodiment of a track project form 800 of the Environmental Project Pipeline System 100. The track project form 800 is displayed to a user when an environmental project and the track project button 511 are selected by a user. The track project form 800 displays tracking information 802 related to an environmental project, including project status, RFP number, rank, initiation date, completion date, follow-up date, participating funding sources, and comments. In addition, the track project form 800 preferably includes an edit status button 804, a close button 806, and a print button 808. When the edit status button 804 is selected an edit status form 900 as in FIG. 9 is displayed to a user. The close button 806 functions to close the track project form 800 when selected by a user and the print button 808 functions to send the track project form 800 to an output device, such as a printer.

FIG. 9 depicts a screen shot of one embodiment of an edit status form 900 of the Environmental Project Pipeline System 100. The edit status form 900 preferably includes a project status drop-down selection box 904, a RFP number drop-down selection box 906, a rank drop-down selection box 908, an initiation text box 910, a completion selection box 912, a follow-up date selection box 914, and a comments text box 916. In addition, the edit status form 900 includes a save button 918 and a cancel button 920 for performing save and cancel functions on the edit status form 900.

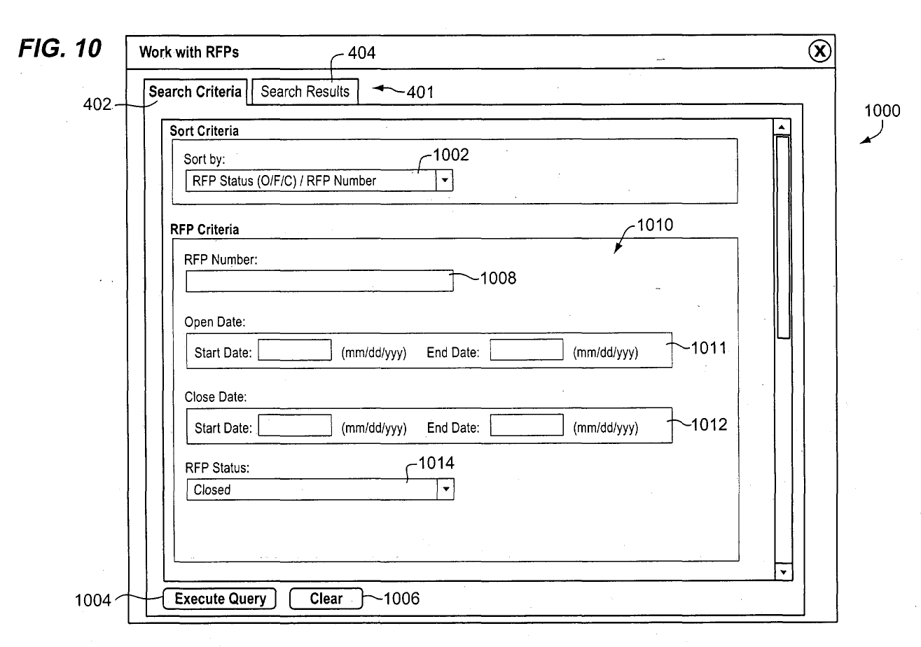

FIG. 10 depicts a screen shot of another embodiment 1000 of a projects search form of the Environmental Project Pipeline System 100. This embodiment of the projects search form 1000 includes a sort criteria drop-down selection box 1002. The sort criteria in this embodiment of the projects search form 1000 is by RFP Status/RFP Number. The projects search form 1000 further includes a RFP criteria section 1010, which preferably includes a RFP number selection box 1008, a open date selection box 1011, a close date selection box 1012, and a RFP status drop-down selection box 1014. In addition the projects search form 1000 includes an execute query button 1004 for executing and displaying the selected search criteria and a clear button 1006 for clearing all selections made in the projects search form 1000.

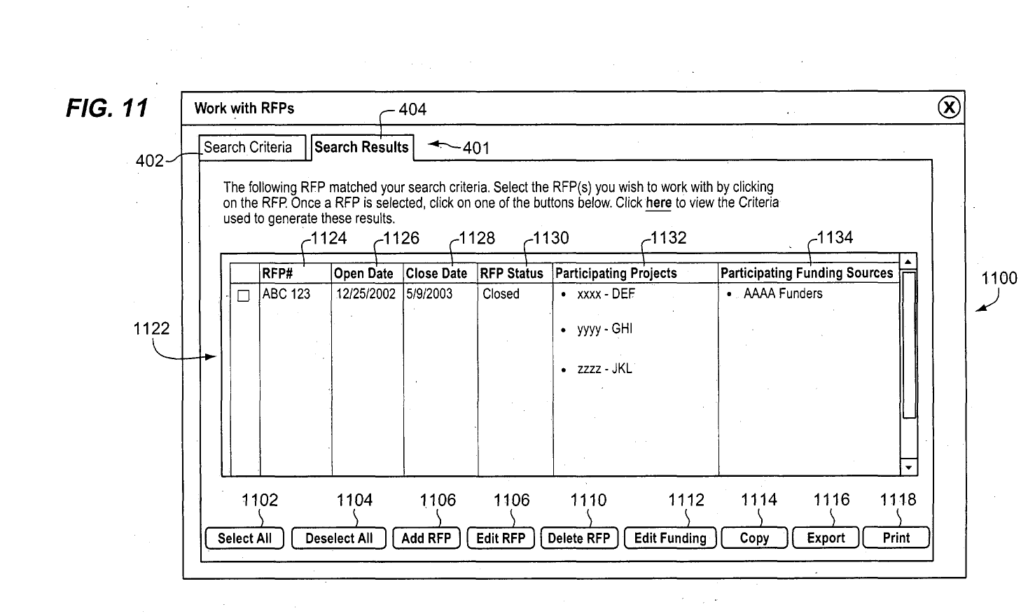

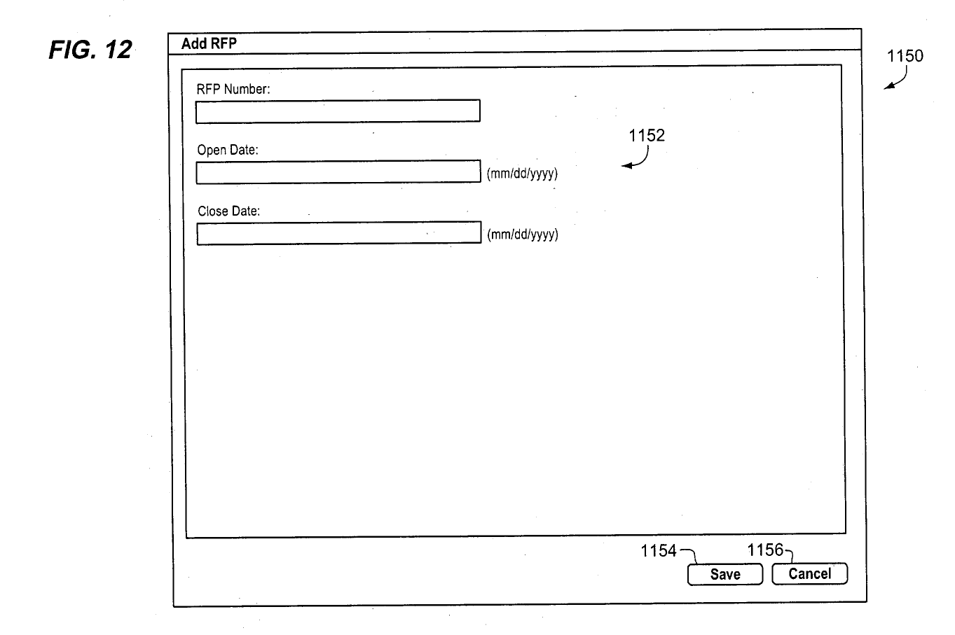

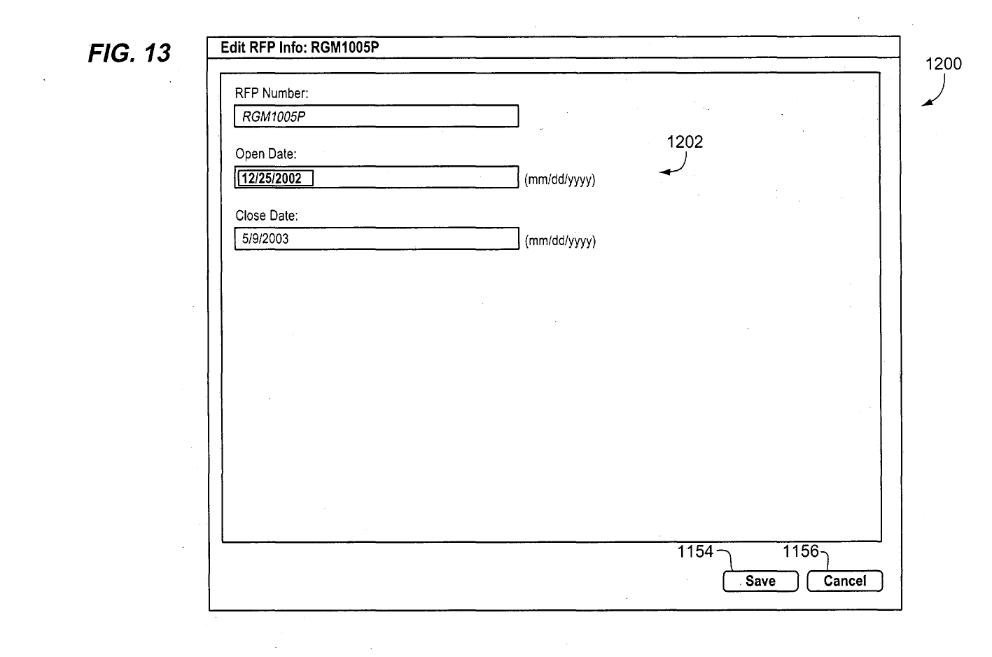

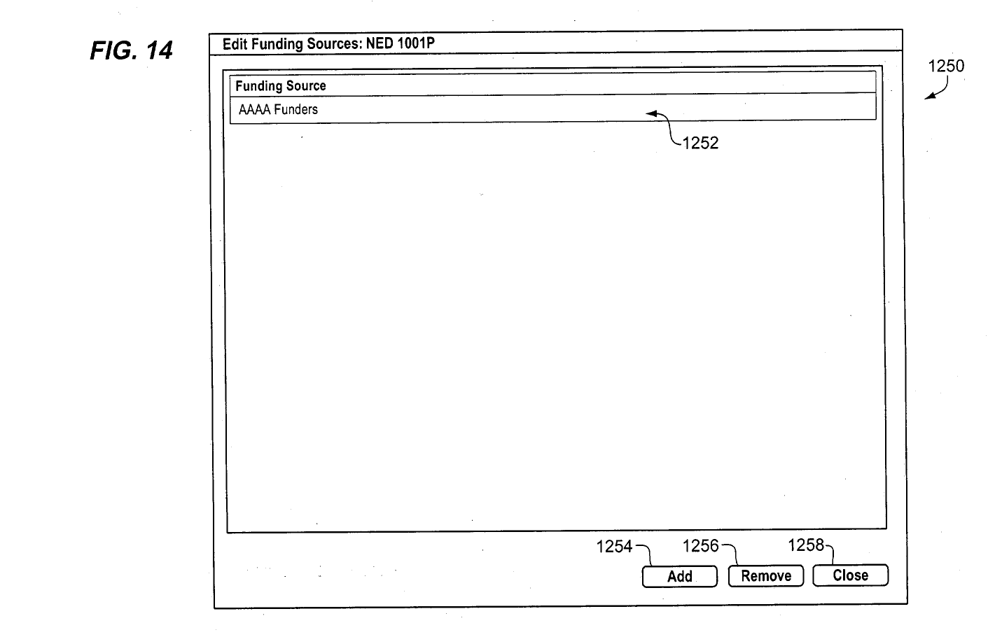

FIG. 11 depicts a screen shot of another embodiment 1100 of the search results report of the Environmental Project Pipeline System 100. Preferably, the search results button 404 is highlighted when this report is displayed. The search results report 1100 includes those environmental projects surveys that have matching criteria with that selected on the projects search form 1000. The search results report 1100 is displayed when a user selects some or all of the criteria displayed on the projects search form 1000 and then selects the execute query button 1004 of projects search form 1000. In one embodiment of the search results report 1100, several columns are displayed to the user including a RFP number column 1124, a open date column 1126, a close date column 1128, a RFP status column 1130, a participating projects column 1132, and a participating funding sources column 1134. Preferably, the search results report 1100 includes a select all button 1102, a deselect all button 1104, a add RFP button 1106, an edit RFP button 1108, a delete RFP button 1110, an edit funding button 1112, a copy button 1114, an export button 1116, and a print button 1118. The select all button 1102 selects all of the displayed projects in the search results report 1100. The deselect all button 1104 deselects all of the projects displayed in the search results report 1100. The add RFP button 1106, when selected, displays an edit RFP form 1150 as shown in FIG. 12, which will be described in more detail below. The edit RFP button 1108, when selected, displays an edit RFP form 1200 as shown in FIG. 13, which will be described in more detail below. The edit funding button 1112, when selected, displays an edit funding source form 1250 as shown in FIG. 14, and will be described in more detail below.

FIG. 12 depicts a screen shot of one embodiment of the edit RFP form 1150 of the Environmental Project Pipeline System 100. The edit RFP form 1150 preferably includes add RFP criteria 1152, including RFP number, open date, and close date. In addition, the edit RFP form 1150 includes a save button 1154 and a cancel button 1156 for performing save and cancel functions when selected by a user.

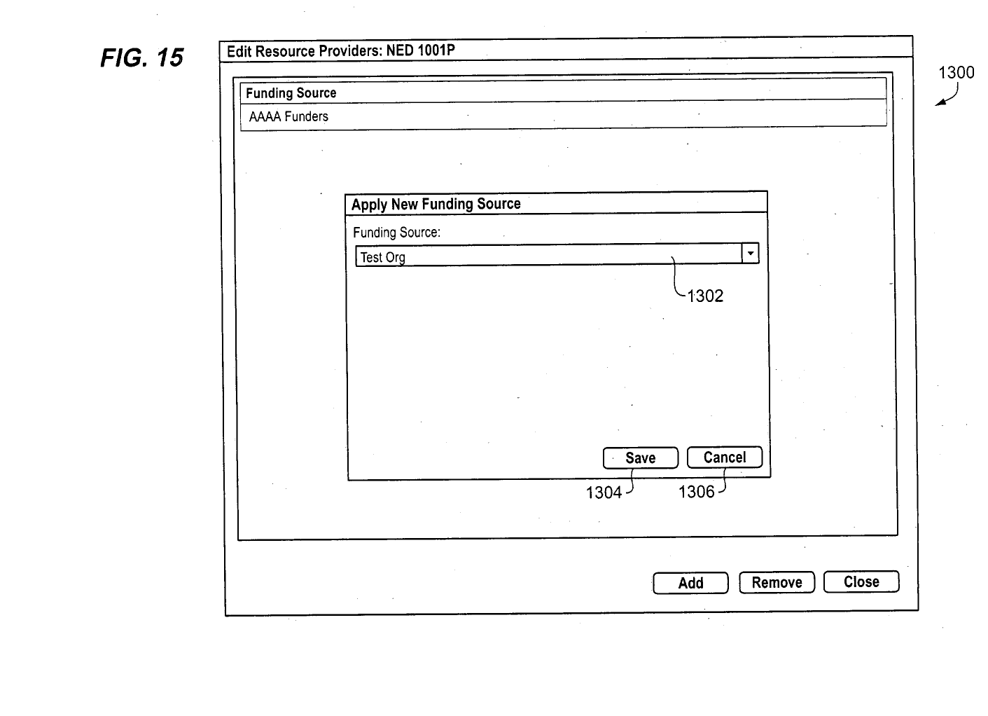

FIG. 13 depicts a screen shot of one embodiment of the edit RFP form 1200 of the Environmental Project Pipeline System 100. The edit RFP form 1200 preferably allows a user to edit RFP criteria information 1202, including RFP number, open date, and close date. The edit RFP form 1200 also preferably includes a save button 1154 and a close button 1156. FIG. 14 depicts a screen shot of one embodiment of the edit funding source form 1250 of the Environmental Project Pipeline System 100. The edit funding source form 1250 preferably includes a highlighted list 1252 showing the funding source to be edited by a user. In addition, the edit funding source form 1250 includes an add button 1254, a remove button 1256, and a close button 1258. The add button 1254, when selected by a user, displays the add funding source form 1300 as shown in FIG. 15, which will be described in more detail below. The remove button 1256, when selected by a user, removes the funding source, from the Environmental Project Pipeline System 100.

FIG. 15 depicts a screen shot of one embodiment of the add funding source form 1300 of the Environmental Project Pipeline System 100. The add funding source form 1300 includes an apply new funding source drop-down selection box 1302, which displays to a user all of the existing resource provider stored in the Environmental Project Pipeline System 100. The add funding source form 1300 further includes a save button 1304 and a cancel button 1306 for performing save and cancel functions once a user has selected a funding source in the apply new funding source drop-down selection box 1302.

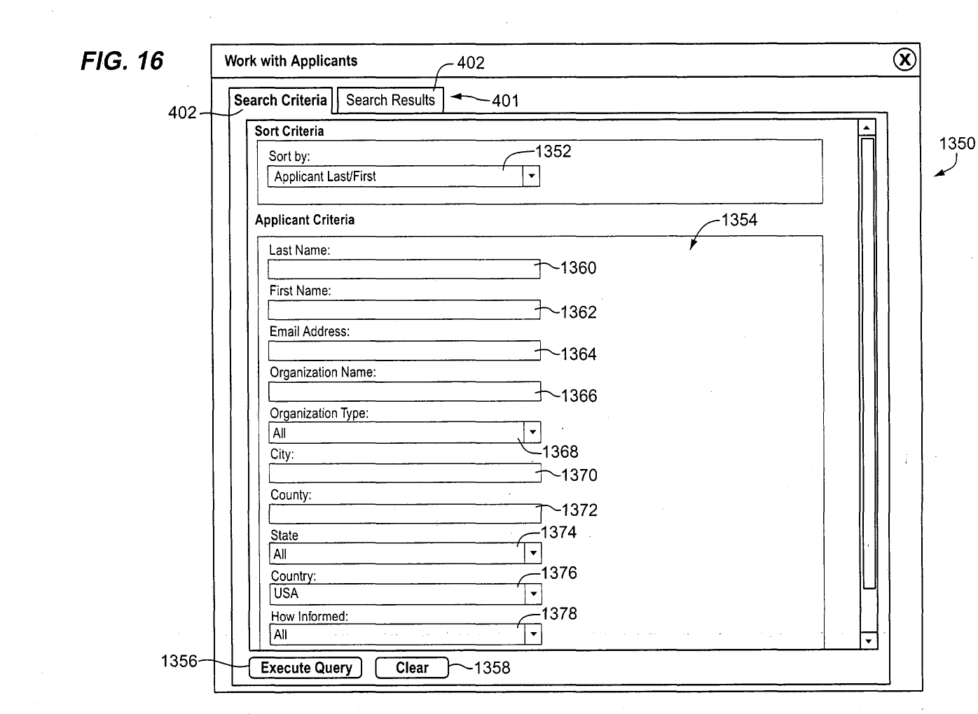

FIG. 16 depicts a screen shot of another embodiment 1350 of a projects search form of the Environmental Project Pipeline System 100. This embodiment of the projects search form 1350 includes a sort criteria drop-down selection box 1352. The sort criteria in this embodiment of the projects search form 1350 is by Applicant last/first name. The projects search form 1350 further includes an applicant criteria section, which preferably includes last name selection box 1360, a first name selection box 1362, an email address selection box 1364, an organization name selection box 1366, an organization type selection box 1368, a city selection box 1370, a country selection box 1372, a state drop-down selection box 1374, a country drop-down selection box 1376, and a how informed drop-down selection box 1378. In addition the projects search form 1350 includes an execute query button 1356 for executing and displaying the selected search criteria and a clear button 1358 for clearing all selections made in the projects search form 1350.

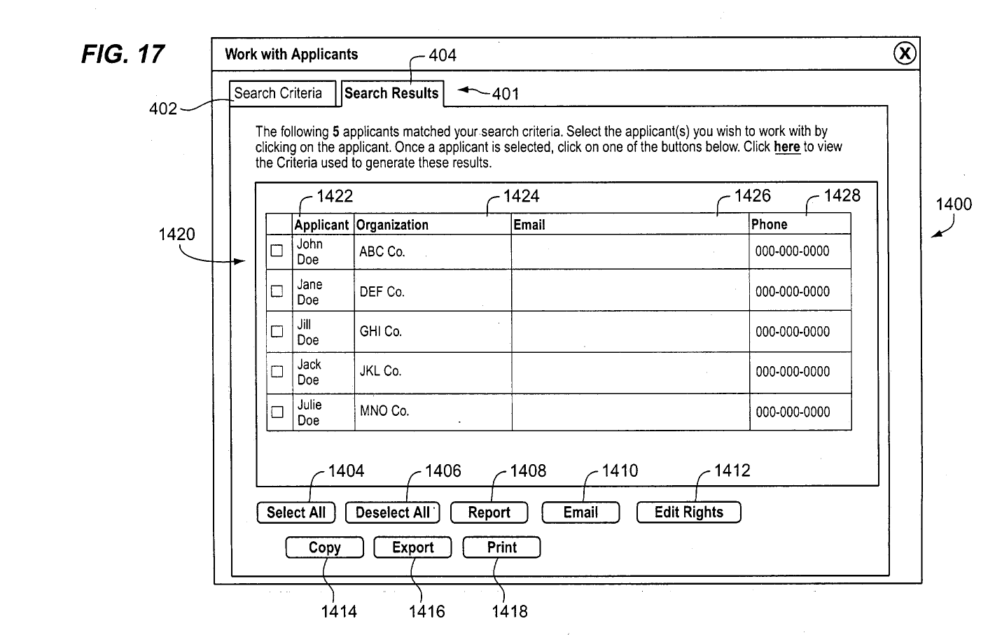

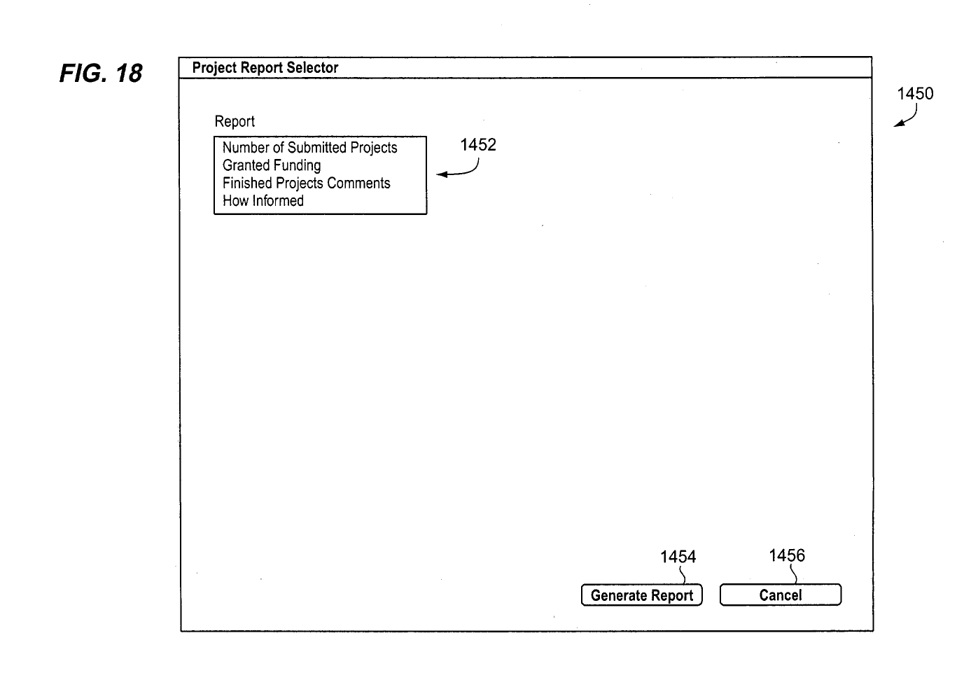

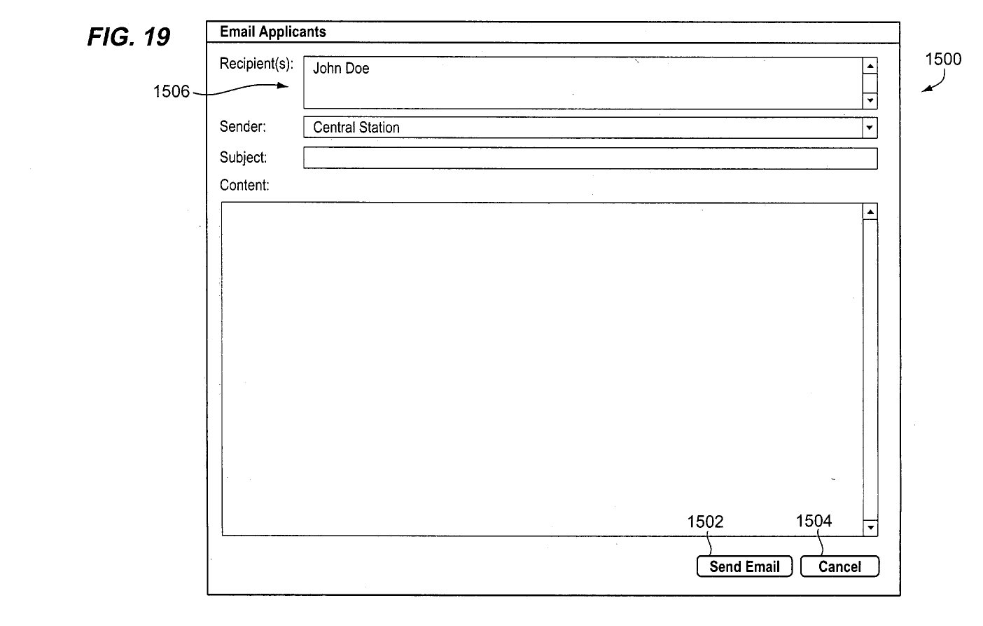

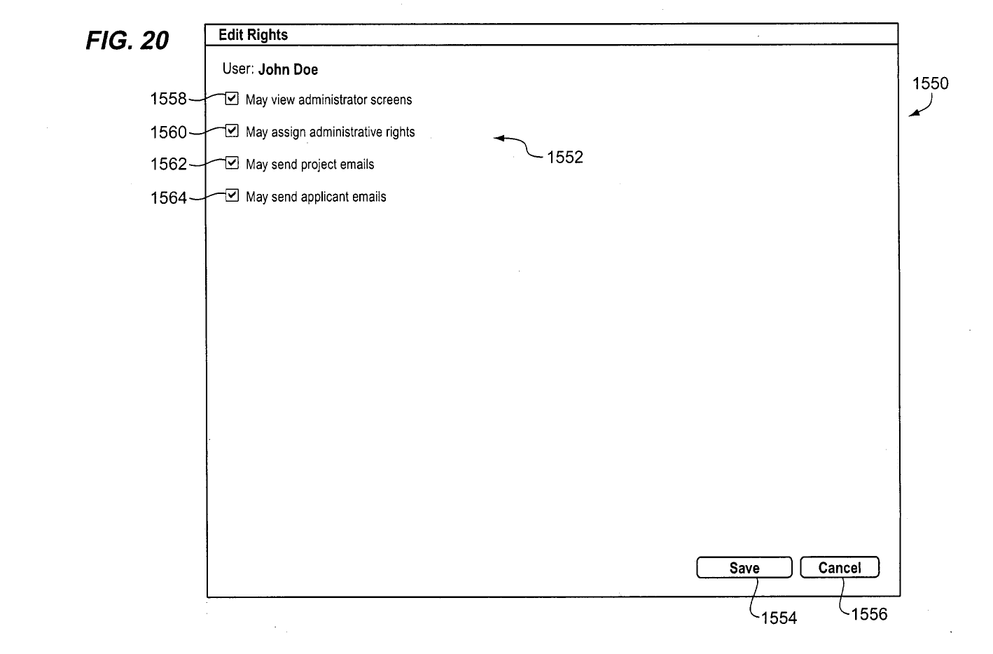

FIG. 17 depicts a screen shot of another embodiment 1400 of the search results report of the Environmental Project Pipeline System 100. Preferably, the search results button 404 is highlighted when this report is displayed. The search results report 1400 includes those environmental projects surveys that have matching criteria with that selected on the projects search form 1350. The search results report 1400 is displayed when a user selects some or all of the criteria displayed on the projects search form 1350 and then selects the execute query button 1356 of projects search form 1350. In one embodiment of the search results report 1400, several columns are displayed to the user including an applicant column 1422, an organization column 1424, an email address column 1426, and a phone number column 1428. Preferably, the search results report 1400 includes a select all button 1404, a deselect all button 1406, a report button 1408, an email button 1410, an edit rights button 1412, a copy button 1414, an export button 1416, and a print button 1418. The select all button 1404 selects all of the displayed projects in the search results report 1400. The deselect all button 1406 deselects all of the projects displayed in the search results report 1400. The report button 1408, when selected, displays a project report form 1450 as shown in FIG. 18, which will be described in more detail below. The email button 1410, when selected, displays an email applicant form 1500 as shown in FIG. 19, which will be described in more detail below. The edit rights button 1412, when selected, displays an edit rights form 1550 as shown in FIG. 20, and will be described in more detail below.

FIG. 18 depicts a screen shot of one embodiment of a project report form 1450 of the Environmental Project Pipeline System 100. The project selector form 1450 preferably includes a report selector box 1452, a generate report button 1454, and a cancel button 1456. A user may select which criteria data category they wish to be included in a report by selecting the desired criteria data in the report selector box 1452 and then selecting the generate report button 1454. One or more of the criteria data category displayed in the report selector box 1452 may be selected.

FIG. 19 depicts a screen shot of one embodiment of an email applicant form 1500 of the Environmental Project Pipeline System 100. The email applicant form 1500 includes an email recipient box 1506 that has the email address of the recipient as selected from the search results report form 1400. The email applicant form 1500 also includes a send email button 1502 and a cancel button 1504. The send email button 1502, when selected, sends the email to the recipient or recipients noted in the email recipient box 1506. The cancel button 1504, when selected, cancels the email applicant form 1500 and returns to the previous display.

FIG. 20 depicts a screen shot of one embodiment of an edit rights form 1550 of the Environmental Project Pipeline System 100. The edit rights form 1550 preferably includes an edit rights check boxes 1552, including a may view administrator screens check box 1558, may assign administrative rights check box 1560, may send project emails check box 1562, and a may send applicant emails check box 1564. In addition the edit rights form 1550 includes a save button 1554 and a cancel button 1556 for performing save and cancel functions for the edit rights form 1550.

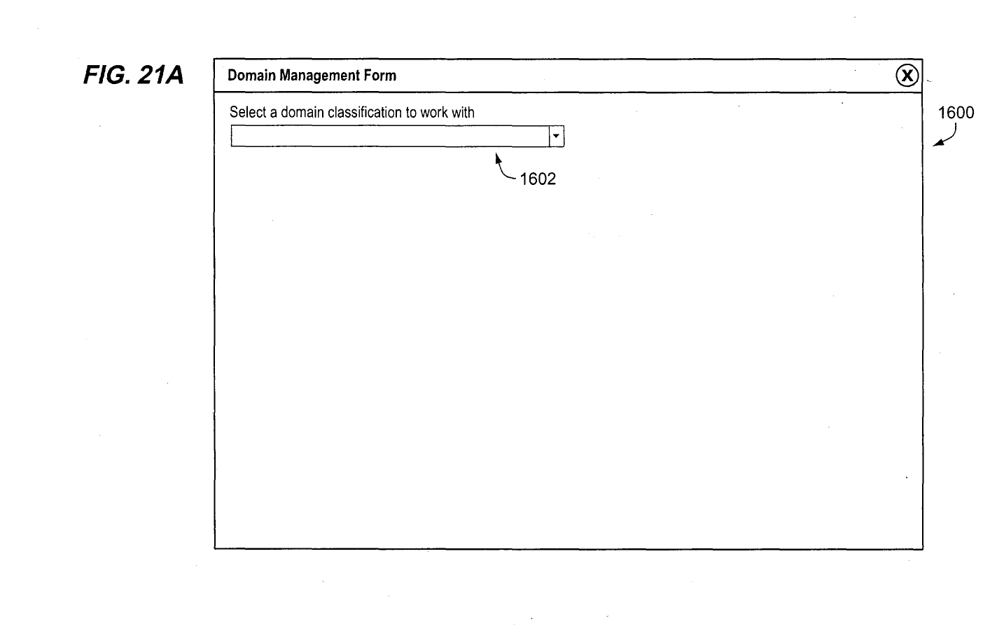

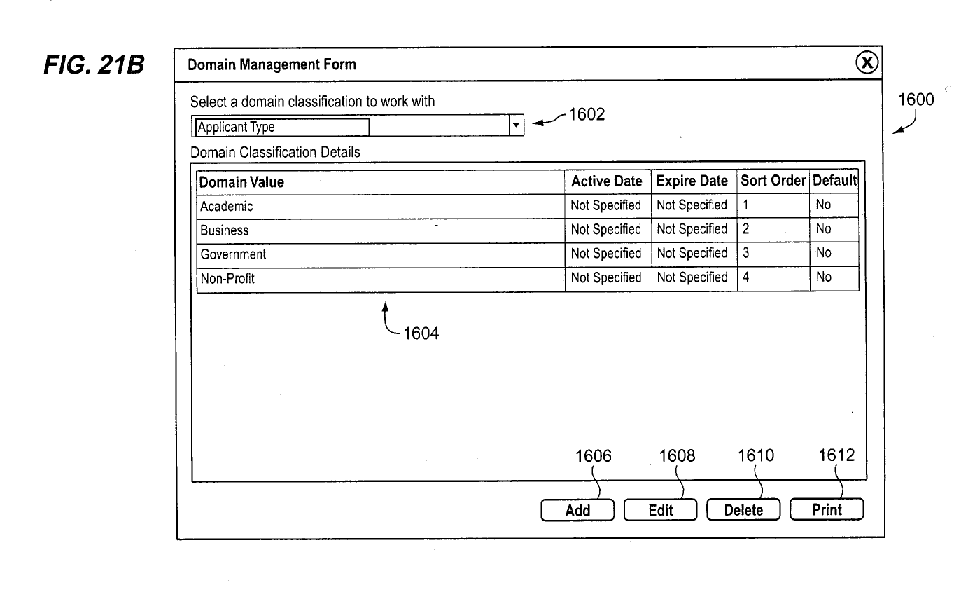

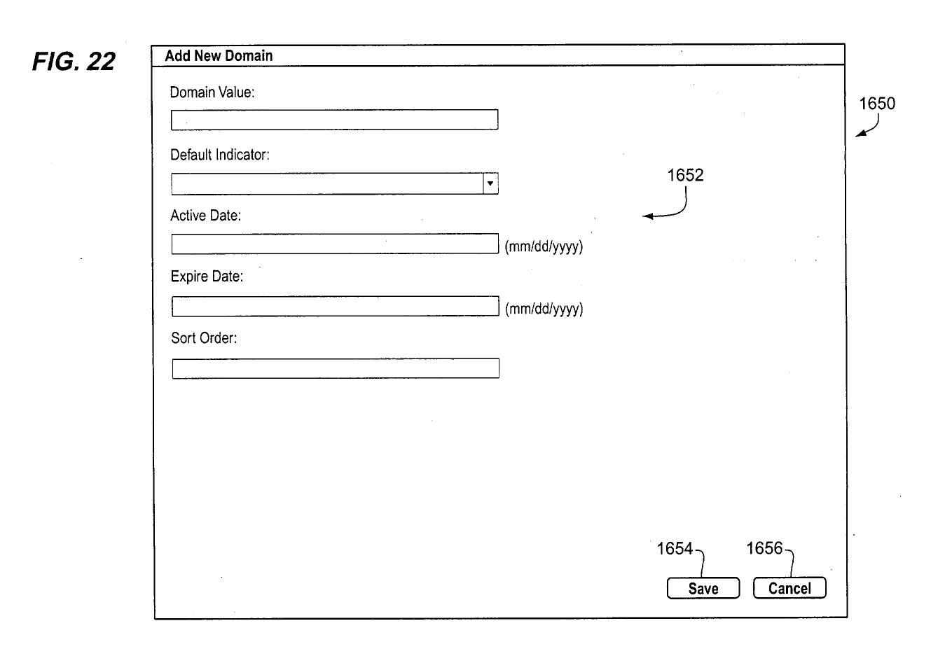

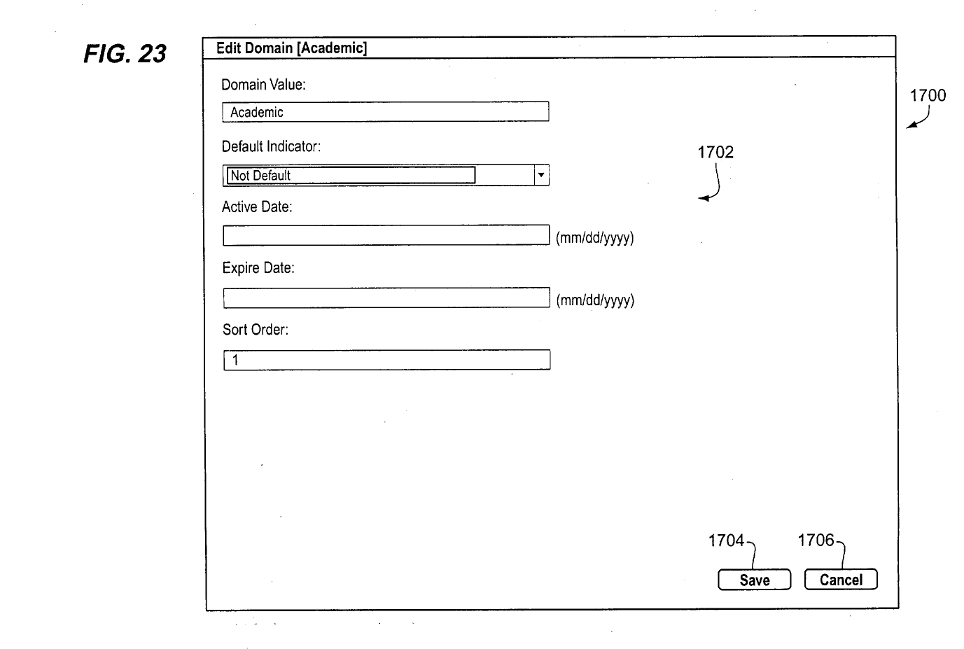

FIGS. 21A-21B depict screen shots of one embodiment of a domain management form 1600 of the Environmental Project Pipeline System 100. The domain management form 1600 includes a domain classification drop-down selection box 1602. When a user selects a domain classification from the drop-down selection box 1602, a domain classification details list 1604 is displayed to the user. The domain management form 1600 preferably includes an add button 1606, an edit button 1608, a delete button 1610, and a print button 1612. When a user selects the add button 1606, an add new domain form 1650 as shown in FIG. 22 is displayed to the user, which will be described in more detail below. When a user selects the edit button 1608, an edit domain form 1700 as shown in FIG. 23 is displayed to the user, which will be described in more detail below. When the delete button 1610 is selected the domain selected in the domain classification list 1604 will be deleted from the Environmental Project Pipeline System 100. When the print button 1612 is selected, a copy of the domain management form 1600 is sent to an output device, such as a printer.

FIG. 22 depicts a screen shot of one embodiment of an add new domain form 1650 of the Environmental Project Pipeline System 100. The add new domain form 1650 preferably includes selection boxes 1652 to enter new domain information, such as domain value, default indicator, active date, expire date, and sort order. In addition, the add new domain form 1650 includes a save button 1654 and a cancel button 1656 for performing save and cancel functions of the add new domain form 1650. FIG. 23 depicts a screen shot of one embodiment of an edit domain form 1700 of the Environmental Project Pipeline System 100. The edit domain form 1700 preferably includes selection boxes 1702 to edit domain information, such as domain value, default indicator, active date, expire date, and sort order. In addition, the edit domain form 1700 includes a save button 1704 and a cancel button 1706 for performing save and cancel functions of the add new domain form 1700.

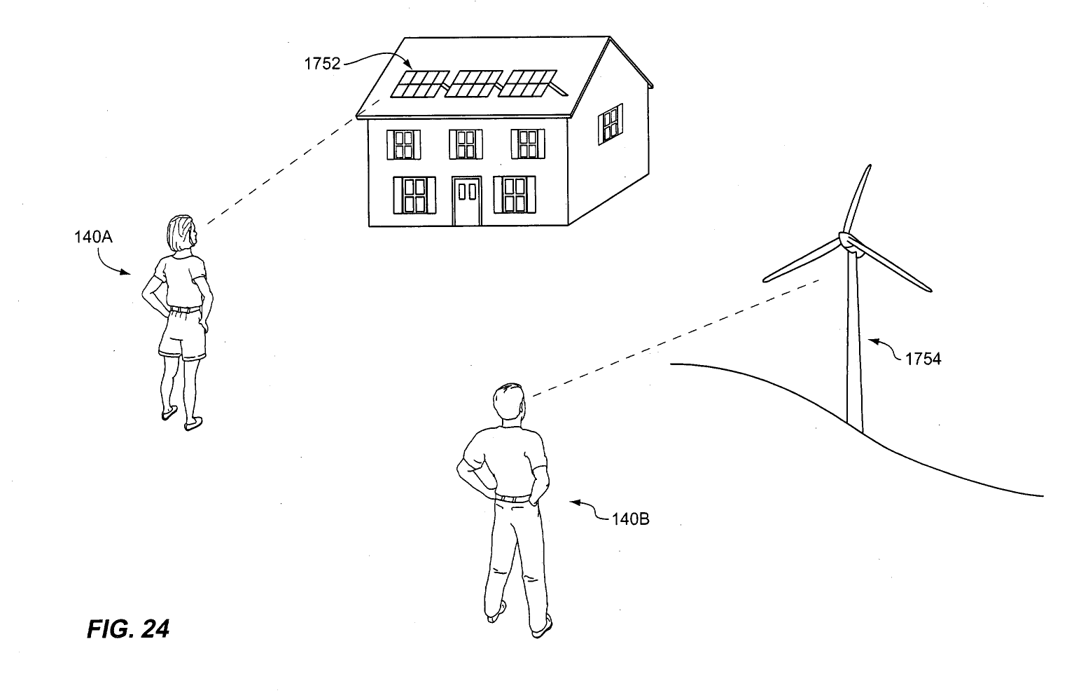

FIG. 24 illustrates users 140A and 140B identifying clean environmental projects including photovoltaic cells 1752 for a building and an electricity generating windmill 1754. Those two environmental projects are shown, these are not limiting, as the entire spectrum of environmental projects in the categories of clean energy projects, energy efficient projects, and pollution prevention projects comport with the use of the present Environmental Project Pipeline System 100. In addition, two users 140A and 140B are shown, however, the number of users integral to the Environmental Project Pipeline System 100 may be one or more. Furthermore, each user, for example 140A, could identify and submit one or more environmental projects.

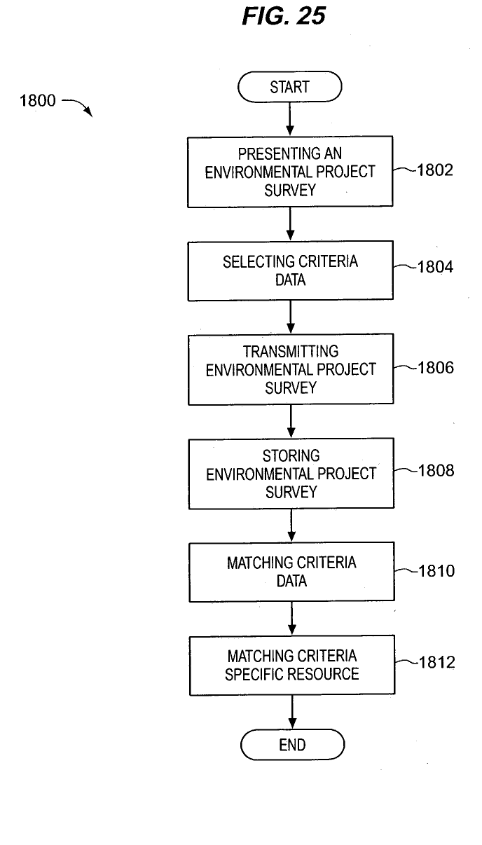

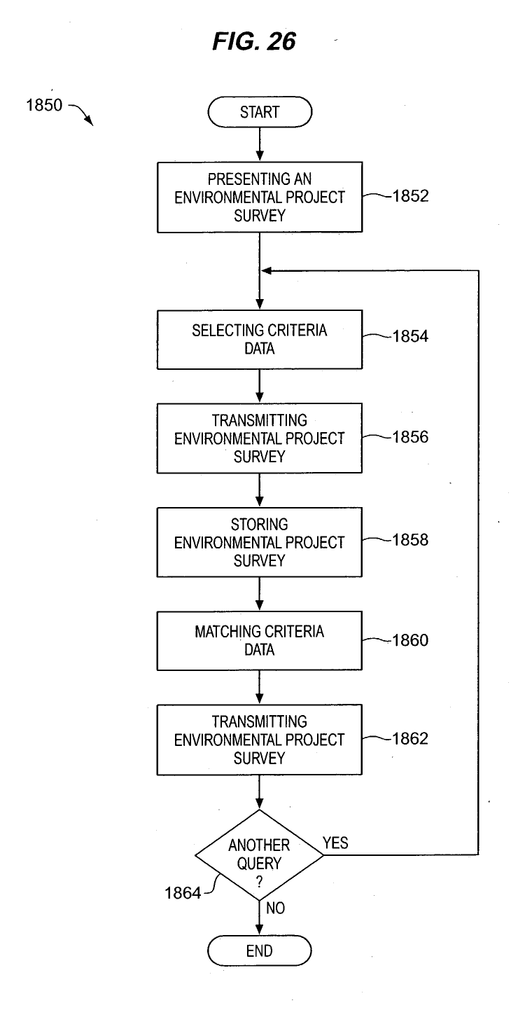

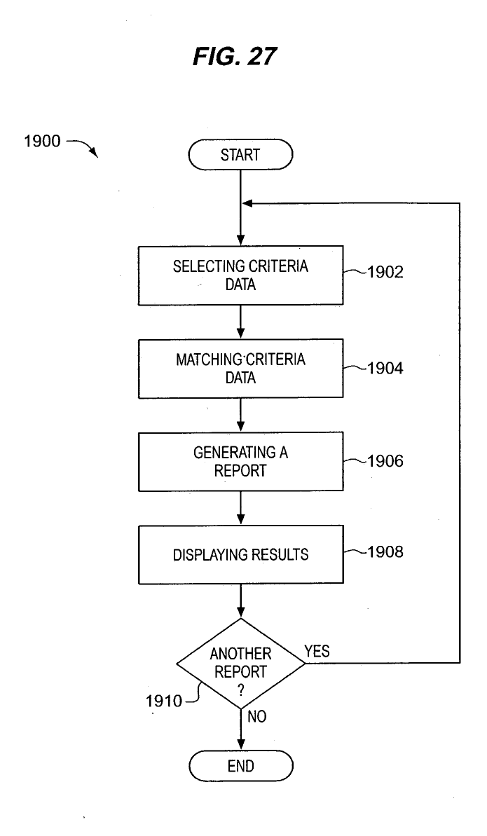

FIGS. 25-27 contain similar functions, so to both of these figures will be discussed together. FIG. 25 illustrates a typical process 1800 to match resource providers 120 with user identified environmental project which involves user's 140A, 140B, and 140C identifying environmental projects, including clean energy projects, energy efficient projects, and pollution prevention projects, such as photovoltaic cells 1752 for a building or an electricity generating windmill 1754. FIG. 26 illustrates a typical process 1850 to inform a resource having specific criteria about a matching user identified environmental project that meets the specific criteria. FIG. 27 illustrates a typical process 1900 to generate a report from a database containing stored user identified environmental projects including at least one criteria data category and a resource including at least one specific criteria. Typically, individuals or organizations (user) identify these environmental projects existing in their community and then connect with the Environmental Project Pipeline System 100 through their computers or other communications devices. Then an environmental project survey 200 is displayed or presented to a computer display 1802, 1852 to the user enabling the user to complete the environmental project survey 200. The user then selects 1804, 1854, 1902 those criteria data category on the environmental projects survey that meet their environmental project. Once the environmental project survey 200 is completed or partially completed, the user then transmits 1806, 1856, via network 150, the completed or partially complete environmental project survey 200 to the central station 102 of the Environmental Project Pipeline System 100. The central station 102 then stores 1808, 1858 the submitted environmental project survey 200 to a database 112.

This matching process 1810, 1860, 1904 comprises the central station 102 searching the criteria data category of the environmental project surveys 200 using a relational database table search function to locate those stored environmental project surveys 200 that match most closely to a known resource provider 120. The central station 102 may search the stored environmental project surveys 200 in a variety of efficient ways, including searching by projects, RFP's, applicants (users), or domains. Once a search option is selected, the central station 102 generates 1906 a report, such as a search results report 500, and then the central station 102 sends or transmits, via email, fax or otherwise, the report to a resource provider 120, where the results can be displayed 1908. Additional reports can be generated 1910. In addition, the central station 102 may notify 1812 a resource provider 120 using partial or whole information related to the matching environmental project survey 200. Additional queries 1864 or matches may be included in the process 1850.

The central station then notifies the user that the environmental project 200 has been received. Periodically, the central station 102 notifies the user 140A regarding the submitted environmental project survey's status. Once an environmental project survey 200 is submitted to the central station 102, the user 140A is able to edit the environmental project survey 200 online as long as the project is not currently under review by a resource provider 120 or being considered under a RFP. In this case the environmental project survey 200 is locked and the user 140A is not able to edit the environmental project survey 200. The central station stores one or more environmental project surveys 200 on the database 112, which is typically a relational database including a query function capable of comparing tables of data stored on the database 112.

In addition, after an environmental project survey 200 has been stored on the database 112 for a year, the environmental project survey 200 is copied over to an archive library 113 and then deleted from the database 112. Prior to this deletion function, the user 140A who submitted the environmental project survey 200 will be notified by the central station 102 that the environmental project survey 200 is going to be deleted and asking the user 140A whether they wish to update the environmental project survey 200. Also, the central station 102 is capable of restoring the deleted environmental project survey 200 by copying the deleted environmental project survey 200 back to the database 112.

Typically the central station 102 acquires resource provider 120 information by soliciting potential and known resource providers 120 over the phone using phone lines 130 or by email over the network 150. These resource providers 120 make known to the central station 102 the funding capacities and project requirements they possess and this information is entered into the central station 102 for later matching with the existing database 112 of environmental project surveys 200. In this way, resource providers 120 can narrowly define their specific request to the central station 102 to enable the central station 102 to efficiently match those stored environmental project surveys 200 that match the resource provider's 120 requirements and report to the resource providers 120 those environmental project surveys 200 that meet the resource provider's 120 requirements.

In addition, the central station 102 tracks the project status of the environmental project surveys 200 as to whether they are a draft, submitted, RFP, awarded, or under review. Furthermore, the central station 102 tracks the environmental project survey 200 by RFP number, rank, initiation date, completion date, follow-up date, and participating funding sources.

### SUMMARY

The Environmental Project Pipeline System includes a central station that uses a server computer including a database and an archive library, the server computer communicating with a computer network to transmit to users an environmental project survey which the users complete relative to an environmental project that they desire to be funded or equipped. To complete the environmental project surveys, users select among various criteria data category contained on the environmental project survey. Once completed, the users submit the environmental project surveys back to the central station where the central station stores the environmental project surveys on the database. The central station further stores criteria data category related to funding sources, or resource providers, on the database. The database includes a relational table search function that searches similar or identical responses contained in the stored environmental projects surveys with those submitted by the resource provider. The central station then notifies the resource providers regarding those stored environmental project surveys that match their criteria data. The central station further notifies the users regarding the status of their submitted environmental project survey, including whether it has been selected for funding.

1. A system for matching user identified environmental projects with resource providers, comprising:
environmental project survey storage means for storing data representative of at least one environmental project survey;
display means, responsive to a user selecting an environmental project survey, for presenting said user with a display of said environmental project survey, said environmental project survey including a plurality of criteria data categories;
input means for enabling said user to input data into at least one of said criteria data plurality of criteria data categories on said environmental project survey;
data transfer means for transmitting said environmental project survey to a central station;
database means located in said central station for storing said environmental project survey and data representative of at least one characteristic of each of said resource providers; and
survey query means operable with said database means for automatically matching said user input data from said environmental project surveys with said data representative of said at least one characteristic of each of said resource providers.

2. The system of claim 1 wherein said user identified environmental projects is selected from the group of projects consisting of clean energy projects, energy efficient projects, and pollution prevention projects.

3. The system of claim 1 wherein said environmental project survey data further includes hierarchically organized tiers of criteria data categories selectable by said user.

4. The system of claim 3 wherein said tiers are selected from a group consisting of a first tier, a second tier and a third tier.

5. The system of claim 4 wherein said first tier comprises criteria data categories selected from the group consisting of air, energy, land, waste, and water.

6. The system of claim 5 wherein said selected first tier displays a second tier of related criteria data categories.

7. The system of claim 6 wherein said selected air first tier displays a second tier of criteria data categories selected from the group consisting of acid precipitation, ambient, indoor, monitoring, noise, odor, pollutants/criteria, pollutants/gases, pollutants/greenhouse, pollutants/particulate matter, pollutants/primary/secondary, radon, sampling, sources/area, sources/fugitive, sources/mobile commercial, sources/mobile fleet, sources/mobile passenger, sources stationary, visibility/pristine, and visibility/urban.

8. The system of claim 6 wherein said selected energy first tier displays a second tier of criteria data categories selected from the group consisting of biofuels, biomass, demand control, energy efficient, energy generation, energy sources, fuel cell, geothermal, hydro, photovoltaics, clean energy certificates, solar, and wind.

9. The system of claim 6 wherein said selected land first tier displays a second tier of criteria data categories selected from the group consisting of agriculture, extractive industries, forest, horticulture, industrial, open space, parks, and residential.

10. The system of claim 6 wherein said selected waste first tier displays a second tier of criteria data categories selected from the group consisting of bio-solids, construction/demolition, fly ash/normal waste, fly ash/special waste, hazardous/biological, hazardous/chemical treatment, hazardous/disposal, hazardous/physical treatment, hazardous/recycling/reuse, hazardous/storage, hazardous/transportation, medical/special wastes, solid/landfills, solid/non-organic, solid/organic, solid/precycle, solid/recycling, solid/reduction, solid/reuse, and solid/waste to energy.

11. The system of claim 6 wherein said selected water first tier displays a second tier of criteria data categories selected from the group consisting of aquifer recharge, “grey” water reuse, ground, industrial re-use, irrigation, non-point treatment, point source treatment, potable, quality, real time monitoring, storm, surface, use reduction, waste (effluent), and wetlands.

12. The system of claim 4 wherein said third tier of criteria data categories is selected from the group consisting of building/design, carbon trading, conservation, consulting, consumer products, ecology/biology, ecotourism, education/training/outreach, emergency response, engineering, equipment sales/rental, financial services, food, geographic information systems (GIS), geology/geophysical, import/export, information systems, legal services, management systems, marketing/communications, natural resource management, packaging/storage, pollution prevention, process/prevention technologies, public health, public policy, remediation, resource recovery, reuse, safety, source reduction, sustainable development, and transportation.

13. The system of claim 1 wherein said environmental project surveys further comprises:
criteria data categories selected from the group consisting of user identified environmental projects funding and cost data.

14. The system of claim 1 wherein said environmental project surveys further comprises:
criteria data categories selected from the group consisting of earliest begin date for said user identified environmental project, latest initiation date for said user identified environmental project, duration of said user identified environmental project, and location of said user identified environmental project.

15. The system of claim 1 wherein said environmental project surveys further comprises:
criteria data categories selected from the group consisting of partner type, target audience, community served, amount of resources required, quantifiable metrics/dollars spent, scalability of the user identified environmental projects, and replicability of said user identified environmental projects.

16. The system of claim 15 wherein said partner type is selected from the group consisting of business, government, non-government, and academic.

17. The system of claim 1 wherein said environmental project surveys further comprises:
criteria data categories selected from the group consisting of user biographical data and free form text.

18. The system of claim 15 wherein said central station further comprises:
reporting means for generating a report from said user selected criteria data category, said report selected from the group consisting of the number of user identified environmental projects submitted, the past funds granted to a user, the past funds granted to a user identified environmental project associated with said partner, and the comments on finished user identified environmental projects for a user.

19. The system of claim 17 wherein said reporting means further comprises:
a report selected from the group consisting of the number of user identified environmental projects submitted within a date range, the number of user identified environmental projects submitted by location, the number of user identified environmental projects matching a specified duration, the number of user identified environmental projects submitted by a specified user, the number of user identified environmental projects that are scaleable, and the number of user identified environmental projects that are replicable, the amount of funds being requested (average), the amount of administration costs being requested (average), the amount of leverage [cash, in-kind, both] (average), the number of projects (or % of projects) per category, the number of projects (or % projects) per target audience, (sorted by location), the number of projects (or % of projects) per partner type (average), and the amount of time to initiate a project (average), the estimated duration of a project (average).

20. The system of claim 1 wherein said data transfer means is selected from the group consisting of world wide web, internet, intranet, and telephony.

21. The system of claim 1 wherein said data transfer means comprises:
encrypted data transfer means for securely transmitting said environmental project survey to said central station.

22. The system of claim 1 wherein said database means further comprises:
a number assigning means for assigning an identification number to each of said environmental project surveys.

23. The system of claim 1 wherein said database means further comprises:
an error checking means for validating said criteria data category selected on said environmental project survey prior to transmission to said central station.

24. The system of claim 1 wherein said central station further comprises:
a receipt confirmation means for notifying said user that said environmental project survey was received by said central station.

25. The system of claim 24 wherein said receipt confirmation means comprises email notification.

26. The system of claim 24 wherein said receipt confirmation means includes said identification number.

27. The system of claim 1 wherein said central station further comprises:
an updating means for allowing a user to update said environmental project survey once it has been transmitted to said central station.

28. The system of claim 1 wherein said central station further comprises:
a locking means for disabling a user's ability to update said environmental project survey once said user identified environmental project is under review by said central station.

29. The system of claim 1 wherein said database further comprises:
code search means for enabling said central station to search for the appropriate code listings that are used to dynamically populate list boxes on said environmental project surveys.

30. The system of claim 29 wherein said code listings is selected from the group consisting of project categories, target audience type, organization type, partner types, applicant type, state codes, and tiers.

31. The system of claim 29 wherein said code search means further comprises:
editing means for allowing an user to perform a function on the code listings selected from the group consisting of browse, add, and delete.

32. The system of claim 1 wherein said database means further comprises:
an archive means for saving said environmental project survey to an archive library.

33. The system of claim 32 wherein said archive means further comprises:
a delete means for deleting said environmental project survey from said database means once said environmental project survey has been archived to said archive library.

34. The system of claim 33 wherein said central station further comprises:
an archive update means that notifies said users that said environmental project surveys will be sent to said archive library on said database means if not updated.

35. The system of claim 34 wherein archive means further comprises:
a restore means for restoring said deleted environmental project survey from said archive library to said database means.

36. The system of claim 1 wherein said database means further comprises:
a dating means for tracking submitted dates and updated dates of said environmental project surveys.

37. A method for matching data representative of at least one resource provider stored in a database located at a central station, with data indicative of a user identified environmental project submitted to said central station through a remote computer, said central station having a server connected to said remote computer through a network, comprising:
presenting said user an environmental project survey to a display connected to said remote computer, said environmental project survey including at least one criteria data category;
inputting data to said at least one criteria data category on said environmental project survey;
transmitting said environmental project survey to said server;
storing said environmental project survey to said database connected to said server; and
automatically matching said inputted at least one criteria data category from said environmental project survey with said data representative of said resource provider.

38. The method of claim 37 further comprising:
notifying said resource provider of said matching at least one criteria from said stored environmental project surveys.

39. The method of claim of claim 38 further comprising:
saving to said database said matching said selected at least one criteria data category from said environmental project survey with said resource provider.

40. A method for informing a resource provider having specific criteria about matching user identified environmental projects submitted to a central station through a remote computer, said central station having a server connected to said remote computer through a network, comprising:
presenting an environmental project survey to a user located at said remote computer, said environmental project survey including at least one criteria data category;
inputting data into said at least one criteria data category on said environmental project survey;
transmitting said environmental project survey to said central station including a database;
storing said environmental project survey to said database;
matching said inputted at least one criteria data category from said environmental project survey with said specific criteria to produce at least one environmental project survey that matches said criteria data category; and
transmitting from said central station to said resource provider said matched at least one environmental project surveys.

41. The method of claim 40 further comprising;
saving to said database said matching at least one criteria data category from said environmental project survey.

42. A method for submitting a user identified environmental project to a central station through a remote computer, said central station having a server connected to said remote computer through a network, comprising:
presenting a user an environmental project survey, said environmental project survey including at least one criteria data category;
selecting said at least one criteria data category on said environmental project survey; and
transmitting said environmental project survey to a central station.

43. The method of claim 42 further comprising:
editing said transmitted environmental project survey after it is stored at said central station.

44. A method of generating a report from a database containing at least one stored user identified environmental project including at least one criteria data category and at least one resource provider including at least one specific criteria, said database connected to a display and an input device, comprising:
selecting said at least one criteria data category to query with said input device;
matching at least one of said criteria data category with at least one of said specific criteria;
generating, responsive to said selecting, said report; and
displaying the results of said report to said display.

45. A method for producing a matched environmental project survey including at least one criteria data category with at least one resource provider comprising:
providing at least one server computer located at a central station in communication with a computer network;
generating at least one environmental project survey from said server computer;
transmitting said at least one environmental project survey from said server computer to at least one remote computer;
inputting at least one of said criteria data category on said at least one environmental project survey;
transmitting said inputted environmental project survey to said at least one server computer;
storing said at least one resource provider at said central station; and
matching said at least one criteria data category from said at least one environmental project survey with said at least one resource provider.

46. The method of claim 45 wherein said matching comprises a relational database match among the stored at least one said criteria data category from said at least one environmental project survey and said at least one said resource provider.

47. An apparatus, comprising:
at least one server computer having a database located at a central station and an interface for communicating over a computer network;
at least one user having an interface for communicating over said computer network with said server computer;
at least one environmental project survey received by said server computer from said at least one user over said computer network;
at least one data representative of a resource provider stored at said central station; and
query means in communication with said server computer and said database for matching said at least one environmental project survey with said at least one resource provider.

48. The apparatus of claim 47 further comprising:
a notification means for notifying said resource provider of said matched environmental project survey.
